(19) United States
(12) Patent Application Publication
(10) Pub. No.: US 2024/0020879 A1
(43) Pub. Date: Jan. 18, 2024

(54) PROOF-OF-LOCATION SYSTEMS AND METHODS

(71) Applicant: YouAR INC., Portland, OR (US)

(72) Inventors: George Howard Alexander BLIKAS, Oak Grove, OR (US); Oliver Clayton DANIELS, Portland, OR (US); Raymond Victor DI CARLO, Portland, OR (US); David Morris DANIELS, Portland, OR (US); Luke Timothy HARTWIG, Portland, OR (US)

(21) Appl. No.: 18/353,464

(22) Filed: Jul. 17, 2023

Related U.S. Application Data
(60) Provisional application No. 63/513,427, filed on Jul. 13, 2023.
(60) Provisional application No. 63/389,688, filed on Jul. 15, 2022.

(51) Int. Cl. G06T 7/73; G06T 7/246

(52) U.S. Cl. CPC G06T 7/74; G06T 7/248; G06T 2207/10028; G06T 2207/30244

(57) ABSTRACT

Systems and methods are described for establishing Proof of Location for a computing device (which may serve as Proof of Location for a user of the device). In some examples, establishing Proof of Location involves trackable features findable by the device at the location in question. In some examples, the computing device is configured to generate a point cloud of a trackable feature for comparison to a reference point cloud. Anti-spoofing methods are described for reducing the possibility of accidental or intentional false-positive Proof of Location results.

### CROSS-REFERENCES

The following applications and materials are incorporated herein, in their entireties, for all purposes: U.S. Provisional Patent Application No. 63/389,688, filed Jul. 15, 2022; U.S. Pat. No. 10,311,643, issued Jun. 4, 2019; U.S. Provisional Patent Application No. 63/513,427, filed Jul. 13, 2023.

### FIELD

This disclosure relates to systems and methods for generating proof of location.

### INTRODUCTION

There are currently many use cases in which people or systems provide basic Proof of Location (e.g., data tending to show that a computing device and/or associated individual is or was at a particular location). For example, a delivery person may capture and send a photo of a package placed outside a customer's door to provide proof to that customer that the delivery driver was at the customer's door at some point in time. However, traditional technologies for providing Proof of Location have various drawbacks, such as relying on a centralized system and being susceptible to fraud and hacking. Thus, there is a need for a more robust system for providing Proof of Location.

### BRIEF DESCRIPTION OF THE DRAWINGS

FIG. 1 is a schematic diagram depicting an illustrative system wherein a single user scans a location to generate and verify Proof of Location (e.g., for the user's own use and/or for another party), in accordance with aspects of the present disclosure.

FIG. 2 is a schematic diagram depicting an illustrative system wherein multiple users generate and verify Proof-of-Location data, e.g., for a server or a third party, in accordance with aspects of the present disclosure.

FIG. 3 is a schematic diagram depicting an illustrative system wherein one user generates and/or verifies Proof-of-Location data for another in a peer-to-peer manner, without the use of an intermediary server, in accordance with aspects of the present disclosure.

FIG. 4 is a schematic diagram depicting an illustrative system wherein three users generate and/or verify Proof-of-Location data, e.g., for themselves, a server, or a third party in accordance with aspects of the present disclosure.

FIG. 5 is a schematic diagram depicting an illustrative system wherein Proof of Location is used in combination with a ledger, in this example implemented via blockchain in accordance with aspects of the present disclosure.

FIG. 6 is a schematic diagram depicting an illustrative system wherein Proof of Location is used to authenticate that a user is who they say they are in accordance with aspects of the present disclosure.

FIG. 7 is a schematic diagram depicting an illustrative system wherein subclouds are used for Proof of Location, in this example as authentication for a financial institution, in accordance with aspects of the present disclosure.

FIG. 8 is a schematic diagram depicting an example in which masking is used to change how a cloud is generated as Verification-of-Location Data to be compared to Proof-of-Location data in accordance with aspects of the present disclosure.

FIG. 9 is a schematic diagram depicting an example in which a hardware mask is used to change how a cloud is generated as Verification-of-Location Data to be compared to Proof-of-Location data in accordance with aspects of the present disclosure.

FIG. 10 is a schematic diagram depicting another example in which a hardware mask is used to change how a cloud is generated as Verification-of-Location Data to be compared to Proof-of-Location data in accordance with aspects of the present disclosure.

FIG. 11 is a schematic diagram depicting an example in which a user receives instructions from a server for how they should move while generating Verification-of-Location data in accordance with aspects of the present disclosure.

FIG. 12 is a schematic diagram depicting a user moving a user device while generating Verification-of-Location data in accordance with aspects of the present disclosure.

FIG. 13 is a schematic diagram depicting a user wearing a head-mounted display and moving their head while generating Verification-of-Location data in accordance with aspects of the present disclosure.

FIG. 14 is a schematic diagram depicting a user wearing a head-mounted display and tracking a shape with their gaze over a trackable background in accordance with aspects of the present disclosure.

FIG. 15 is a schematic diagram depicting an example in which data about locations stored at a third-party database can be converted into Proof-of-Location data and verified by a device as useable Proof-of-Location data in accordance with aspects of the present disclosure.

FIG. 16 is a schematic diagram depicting an example in which a user generates a location-verified photo or video of an event in accordance with aspects of the present disclosure.

FIG. 17 is a schematic diagram depicting an example in which multiple users generate Proof of Location for themselves without a nearby trusted trackable feature in accordance with aspects of the present disclosure.

FIG. 18 is a schematic diagram depicting an example system for preventing a “Man-in-the-middle” attack from spoofing a Proof-of-Location event in accordance with aspects of the present disclosure.

FIG. 19 is a schematic diagram of an illustrative data processing system suitable for use as or with aspects of the present disclosure.

FIG. 20 is a schematic diagram of an illustrative distributed data processing system suitable for use as or with aspects of the present disclosure.

### DETAILED DESCRIPTION

Various aspects and examples of Proof-of-Location systems, as well as related methods, are described below and illustrated in the associated drawings. Unless otherwise specified, a Proof-of-Location system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, the present disclosure describes Proof-of-Location systems and methods for verifying the location of a device (e.g., a mobile digital device such as a cell phone), and for reducing the possibility of accidental or intentional false positive verifications. Proof of Location provided by the systems or methods disclosed herein may be utilized for a variety of different purposes including but not limited to multi-factor-authentication protocols, credit card fraud detection, package delivery verification, location-based blockchain technologies, etc.

Proof-of-Location systems in accordance with aspects of the present teachings facilitate creating Proof of Location for a user, a device, and/or an object (e.g., a strong basis for believing that a user, a device, and/or an object was or is at a particular location). The term “Proof of Location” may be used to refer to data and/or notifications indicating that a location of a device, person, and/or object has been verified (e.g., data indicating that a Proof-of-Location method has successfully shown that the user is at a particular location and/or was at a particular location at a particular time). For example, a server that verifies that a user's device has been established to be at a particular location may provide Proof of Location to the user and/or to a third party in the form of a message, passcode, and/or other suitable data or notifications.

A Proof-of-Location method generally confirms (or disconfirms) that a device, person, and/or object was at a specific location at a specific time. A simple example of such a method is a software application querying a device's GPS functionality to obtain data identifying the device's location (e.g., GPS coordinates). Another example is geofencing, which utilizes radio frequency identification (RFID), Wi-Fi, and/or GPS to locate a device and determine if the device has entered or exited a virtual geographic boundary. However, these examples rely on trusting the device to provide accurate location information to accurately verify the device's location.

Proof-of-Location systems and methods in accordance with aspects of the present teachings avoid this problem. In some examples, Proof-of-Location systems and methods as described herein involve a device receiving Proof-of-Location data and, based on the Proof-of-Location data, generating Verification-of-Location data usable (e.g., by a remote verifier such as a server, blockchain, a peer in a peer-to-peer network, etc.) to determine whether the device is in a particular location (or was at that location at the time of generating the Verification-of-Location data). Proof-of-Location data may comprise any data suitable for facilitating the device generating Verification-of-Location data that allows for establishing Proof of Location with high confidence (e.g., because it would be difficult for a device not truly present at the location to purposefully or inadvertently create Verification-of-Location data that would falsely establish Proof of Location). In some example systems and methods, however, a device generates Verification-of-Location data without having received Proof-of-Location data (for instance, because it is clear from context or for other reasons how the Verification-of-Location data should be generated, because the system is configured to accommodate any or almost any Verification-of-Location data the device could generate at the location, and/or for any other suitable reason).

The present disclosure includes illustrative examples of Proof-of-Location data and Verification-of-Location data configured to facilitate establishing Proof of Location, illustrative examples of anti-spoofing methods configured to reduce the likelihood that Proof of Location will be falsely established, and illustrative systems and methods related to Proof of Location.

Certain examples described herein refer to users using mobile digital devices such as smartphones to implement aspects of Proof-of-Location systems and methods. However, any suitable computing devices (e.g., including devices not typically mobile during ordinary use) may be used. In some examples, wearable technology is used. In some examples, aspects of Proof-of-Location systems and methods (including aspects described in examples herein as involving human users) are carried out by non-human devices, such as autonomous devices (e.g., drones) and/or other autonomous or semi-autonomous computing devices (e.g., programmed to perform functions to carry out aspects of the systems and/or methods and/or remotely controlled by a human or computer to perform the functions).

The following paragraphs of the Overview describe illustrative aspects of systems and methods related to Proof of Location.

In some examples, Proof-of-Location systems and methods utilize trackable features disposed at a location or in an environment to ascertain that a user is or was at the location. A “trackable” may comprise any feature (e.g., a physical feature or object in a real-world environment) or set of features that a mobile device is able to identify and calculate the device's position relative to. Trackables may include, but are not limited to, an object or a portion of an object disposed at a location, a portion of a building (e.g., a corner of the building), an arrangement of two or more objects or object portions, and/or any other identifiable feature at a location. A trackable, in the context of the present disclosure, need not be an entire object or building, and may refer to just a portion of the object or building. In some examples, a trackable feature and/or a portion of a trackable feature is used (or suitable for use) by augmented reality (AR) technology; for example, the trackable may be a feature that is trackable by AR technology and/or may be an “anchor” upon which AR objects can be placed.

A trackable feature may be utilized by the mobile device to determine position information for the mobile device relative to the trackable. If the trackable has a known location and the position of the device relative to the trackable feature is determined, the location of the device can be inferred. For example, generating Verification-of-Location data may include generating a point cloud of a trackable and/or attempting to relocalize to a trackable. The device may generate the Verification-of-Location data based on Proof-of-Location data received from another device, such as a server; for example, the Proof-of-Location data may identify the trackable feature the device should attempt to generate a point cloud of and/or localize to.

In some examples, the known location of the trackable comprises a global coordinate position of the trackable, such as a set of World Geodetic System (WGS) coordinates, and a global coordinate position of the mobile device is estimated based on the global coordinate position of the trackable. In some examples, the known location is simply an understanding (e.g., on the part of a system user) that a trackable would very likely only be within sensor range of a device disposed at a particular location.

Different locations and different trackable features may have different levels of transience. Transience, in the context of the present disclosure, refers to how the trackable features at a location change over time. Locations with high transience have trackable features that move or change regularly and locations with low transience remain relatively unchanged through time (e.g., through a relevant timeframe). Changes in the trackable features at a location may occur due to physical movement of the trackable features and/or other objects that may affect a mobile device's ability to recognize a trackable feature, due to changes in light levels at the location throughout the day, and/or due to any other factors at the location that change throughout the day and/or year. The transience of the trackable features at a location may need to be accounted for when generating Proof of Location for a user at the location.

In some examples, the Proof-of-Location systems disclosed herein generate and utilize feature descriptors relating to trackable features, facilitating identification of the trackable features based on the feature descriptors in images or video including the trackable features. A feature descriptor comprises data points extracted from an image or video that relate to and enable identification of a specific trackable feature in the image. For example, a feature descriptor of a trackable feature may include a point cloud representing the trackable feature. The Proof-of-Location system may utilize a feature descriptor extraction algorithm to generate the data points relating to the one or more trackable features in an image. The generated feature descriptor for the trackable feature can be utilized to identify the trackable feature in different images including the same trackable feature. In some examples, the feature descriptors are disposed around points of high contrast in an image, which facilitates identifying the feature in different photos having different scales or light levels. For example, a feature descriptor may be arranged such that a lighter area of an image is on one side of the feature descriptor and a darker area is on the other side. In some examples, a feature descriptor defines an angle between the light-dark divide of an image. In some examples, a feature descriptor is a point in a field that is lighter or darker than the point. Suitable feature descriptor extraction algorithms may include, but are not limited to, ORB, SIFT, SURF, RIFT, and/or the like.

In some examples, a mask is utilized to mask out a portion of an image or video captured by a mobile device. Masking out may include, e.g., removing a 2D segment from the image and/or from the image data points that are generated (or that would have been generated if not prevented by the mask) by the feature descriptor extraction algorithm in an image, and/or may include removing a 3D segment of a normal environment from a field of view of the mobile device. The removal may be performed by software algorithm(s) (e.g., by selectively removing a segment of image data from an image acquired by an image capture device); by physically placing an object in the way of the image capture device, such that a segment of image that would otherwise be included in an acquired image is blocked by the object; and/or in any other suitable manner. In some examples in which Proof of Location is used to establish successful delivery of a package, applying a mask may include placing the package such that it partially obscures a specific feature or anchor at a location from the point of view of a device capturing an image of the location, such that a portion of the feature is masked in the captured image. In some examples, the mask is applied to a field of view of the mobile device by one or more algorithms on the mobile device. For example, a portion of the image capture device of the mobile device (e.g., a subset of a CMOS or CCD array of a camera) may be selectively disabled to “mask out” a segment of the field of view that would otherwise have been captured. Alternatively, or additionally, a hardware mask may be applied to the CMOS of the user device to physically inhibit a portion of the CMOS chip from receiving light.

Proof-of-Location systems in accordance with aspects of the present disclosure may include a user device (e.g., a smart phone) configured to execute one or more software applications. In some examples, one or more applications configured for augmented reality functions are used (e.g., AR-enabled software applications). The one or more software applications may be configured to receive images and/or video captured by the user device and generate data relating to trackable feature(s) in the images or video. For example, the one or more software applications may include one or more feature descriptor extraction algorithms and/or any other suitable computer vision algorithms configured to generate a point cloud of one or more trackable features in the images or video. In some examples, the one or more software applications include one or more algorithms configured to localize the device to a previously generated point cloud of a trackable feature in the images or video (e.g., to obtain position, location, and/or orientation information of the device by using the previously generated point cloud to recognize the trackable feature). In some examples, the user device is configured to communicate with other user devices, a server, a blockchain, and/or a third-party system, such that the data generated or extracted by the one or more software applications may be communicated to the other user devices, the server, the blockchain, and/or the third-party system. The other user devices, the server, the blockchain, and/or the third-party system may also communicate information to the user device.

In some examples, the software application on the user's mobile device is configured to request, from a server, blockchain, third party, and/or another user device, Proof-of-Location data associated with a specific location the user device claims to be at. The Proof-of-Location data received from the server may include any suitable data that can be utilized by the user device to verify an at least approximate position, location, and/or surrounding environment of the device. For example, Proof-of-Location data may include an identification (ID) of a nearby beacon, a point cloud of a trackable feature in the surrounding environment of the device, a specific region and/or feature of the surrounding environment for which a point cloud is to be generated, a mask to apply to a field of view of the user device, etc.

Additionally, or alternatively, the Proof-of-Location data may include directions or instructions for the user of the user device to follow. For example, the Proof-of-Location data may instruct the user of the device to move the device in a certain way (e.g., rotating and/or translating the device spatially) when capturing a video or images of the surrounding environment to be input into the AR software application. In some examples, the Proof-of-Location data may instruct the user of the user device to place an object over a specific feature in the surrounding environment, such that the object masks at least a portion of the feature.

In some examples, the software application of the user's mobile device is configured to receive as input the Proof-of-Location data and a series of images or a video feed of the environment surrounding the user device (acquired, e.g., by an image sensor of the device and/or other suitable sensor in communication with the software application), and to generate Verification-of-Location data based on the input. Verification-of-Location data may include any information that may be utilized by a remote verifier (e.g., a remote server) and/or utilized by the device itself to verify that the device is at the location associated with the received Proof-of-Location data. For example, Verification-of-Location data may include a generated point cloud of a trackable feature and/or data relating to a relocalization of the device to a previously generated point cloud at the location.

The type of Verification-of-Location data to be generated by the software application is generally dependent on the type of Proof-of-Location data received by the application. For example, if the Proof-of-Location data includes a previously generated point cloud of a trackable feature in the environment surrounding the user device, generating the Verification-of-Location data may include relocalizing the device to the point cloud of the trackable feature and generating data relating to which points of the point cloud are tracked to and how often. The generated data is the Verification-of-Location data. As another example, if the Proof-of-Location data includes data specifying a location in the surrounding environment, generating the Verification-of-Location data may include generating a point cloud at the specified location. In some examples, Verification-of-Location data includes information relating to any masks applied to the images or video captured by the user device of the surrounding environment.

In some examples, the Verification-of-Location data includes an identification (ID) received from a beacon disposed at and/or within range of a location. Receiving the ID transmitted by the beacon verifies that the device is close enough to the beacon to receive the ID and thus establishes Proof of Location for the device.

In some examples, Verification-of-Location data generated by the software application is sent to a remote verifier (e.g., the server, third party, etc.) to be utilized by the remote verifier to establish Proof of Location for the user device (e.g., to determine that the user device has been established to be in the location in question). The remote verifier may determine, based on the Verification-of-Location data, whether the user device is at the location associated with the Proof-of-Location data sent to the user device.

For example, if the Verification-of-Location data includes a point cloud of a trackable feature in the environment of the user device generated by the user device, the remote verifier may utilize one or more algorithms to compare the generated point cloud to a previously generated reference point cloud of that trackable feature. Based on the comparison, the remote verifier determines whether the point cloud generated by the user device is the same as the reference point cloud (e.g., identical to the reference point cloud within a predetermined tolerance). A satisfactory match between the generated point cloud and the reference point cloud is verification that the device is at least in view of the trackable feature at that location.

In some examples, the Verification-of-Location data includes information obtained based on relocalizing the device to a given point cloud. For example, the Verification-of-Location data may include data indicating which points of the point cloud were tracked to by the user device and how many times each point was tracked to, and the remote verifier may be configured to determine, based on that data, whether the likelihood that the device really did relocalize to the point cloud is sufficiently high.

In some examples, a mask is applied to the images or video during generation of the Verification-of-Location data by the device, and the remote verifier accounts for the applied mask when analyzing the Verification-of-Location data.

In some examples, semantic logic is utilized by the server to provide Proof of Location for the user device. For example, the Verification-of-Location data sent from the user device to the server may include one or more images of the environment where the user device is located. The server is configured to semantically recognize one or more objects in the image as objects of a kind expected to be at the location (and/or to semantically recognize one or more segments of the image as a known portion of the location, such as a part of a room). For example, the server may have data (or be configured to access or receive data) indicating that the location is expected to have two red chairs and a table, and the server may be configured to semantically recognize that the received images of the environment do include two red chairs and a table. After the server has determined that an expected object is present (or that a suitable number and/or combination of expected objects are present), the server provides a confirmation of Proof of Location for the user device. Semantic Proof of Location methods may be utilized in combination with other methods (e.g., trackables, GPS, beacons, etc.) described above to provide increased confidence in the generated Proof of Location. In some examples, semantic Proof of Location methods may be utilized to establish Proof of Location alone (e.g., without the use of other techniques described above).

In some examples, additional verification of Proof of Location may be desired beyond the Proof of Location provided by the software application or remote verifier, as described above. In some examples, this additional verification is provided by utilizing a system including information relating to the relative positions of trackable features, such as at least some examples of the LockAR system described in U.S. Pat. No. 10,311,643B2. For example, if information relating to a first one of a plurality of trackables is included in the Proof-of-Location data received by the user device, the device may track to the first trackable and also to a second trackable for which positioning information relative to the first trackable is known. If the device successfully tracks to the first and second trackables, Proof of Location may be established with increased confidence.

In some examples, additional verification is provided by having a second user go to the location at which the first user generated the Verification-of-Location data. The second user generates their own Verification-of-Location data using a second user device and the Verification-of-Location data generated by the second user device is compared (e.g., by a server or other remote verifier) to the Verification-of-Location data generated by the first user device to provide additional verification that the first user device was in the claimed location.

In some examples, Peer-to-Peer verification may be utilized to verify the Proof of Location of a first user. Peer-to-Peer location verification utilizes a second user rather than (or in addition to) a server or other remote verifier to verify the location of a first user. For example, the second user may have a known location and may act as a beacon and/or a hotspot to verify that the first user is nearby. In such examples, the second user may have recently generated a point cloud of a trackable feature of the environment and transmitted the generated point cloud to a remote verifier to verify their location. Accordingly, proof of the first user's location can be obtained based on the remote verifier's verification of the second user's location together with an indication that the first user is near the second user (e.g., within range of a beacon ID transmitted by the second user). The indication that the first user is near the second user may be obtained by the first user's device, by the second user's device, by another device, by any suitable combination of devices, and/or in any other suitable manner. In some examples, multiple second users are utilized to verify the location of the first user (e.g., two second users may each independently verify their locations with the remote verifier, and the first user (or one or both second users, or a combination of the first user and one or both second users) obtains information sufficient to determine that the first user is near both second users). Utilizing multiple second users to verify the location of the first user increases the confidence in the Proof of Location of the first user.

Proof-of-Location systems in accordance with aspects of the present teachings may implement one or more of various measures, techniques, and/or practices to ensure accurate verification of location for a user, such as anti-spoofing techniques. Spoofing refers to methods and techniques utilized by a user to “trick” an application, server, and/or a third party into verifying the user's location when the user is not actually at the location (e.g., to obtain a false verification). One type of spoofing that could be utilized by a user is modifying the Verification-of-Location data sent to a remote verifier, such that the remote verifier is tricked into verifying the location of the user. For example, if relocalization of a device to a point cloud is being utilized to verify the location of the user, the user may modify the Verification-of-Location data their device obtains to falsely indicate that each point in the point cloud was tracked to multiple times. For example, this spoofing method could be used by a user who is not actually at the location but has data corresponding to a point cloud of the trackable, and is able to modify that data.

Another type of spoofing a user could utilize is editing inputs into the software application configured to generate the Verification-of-Location data. For example, a user could modify images or a video feed utilized by the software application to make it appear as though the device is at a location, when the device is not actually at the location. The user could, e.g., input a previously acquired video or image of the location, render a 3D model of the location, and/or input a live video of the location obtained from another source (e.g., a CCTV camera of the location).

Anti-spoofing measures utilized by the Proof-of-Location systems of the present teachings reduce or eliminate the likelihood that spoofing methods will succeed. Anti-spoofing measures may include, without limitation, utilizing encryption of the Proof-of-Location data and/or Verification-of-Location data sent between the device and the server or blockchain, on-device encryption, utilizing a mask to mask out specific portions of an image, salting a point cloud, parameterized point cloud generation, etc. In some examples, one or more machine learning algorithms are utilized to detect when data is likely being spoofed or is too perfect. In some examples, a user may be required to move the camera of the user device in a specific way when capturing the images or video to be input into the software applications to generate Verification-of-Location data. Having the user move the camera in a specific way increases the difficulty of generating (or otherwise acquiring) false images capable of successfully obtaining false verification when input into the application.

In some examples, the Proof-of-Location data utilized by the application to generate the Verification-of-Location data is modified as an anti-spoofing measure. For example, the Proof-of-Location data communicated by the server to the user device may only include a randomized subset of the data points of a first point cloud of a trackable feature. The software application of the user device may scan the trackable feature to generate Verification-of-Location data comprising a second point cloud that includes the points of the first point cloud that were omitted from the randomized subset of data points communicated to the device by the server. The server may compare the points of the first point cloud that the server omitted from the randomized subset to the generated second point cloud to determine whether the device is actually in view of the specific trackable feature at the location.

In some examples, the Proof-of-Location data may include a “salted” point cloud of a trackable feature. A salted point cloud includes certain false data points that do not actually correspond to the trackable feature. In such examples, the application of the user device may receive the salted point cloud and attempt to relocalize the device to the point cloud. While relocalizing the device to the point cloud, the application generates Verification-of-Location data including information relating to which points of the point cloud are tracked to and how often. It would not be possible for the false data points to actually be tracked to, because they do not correspond to the actual trackable feature. Accordingly, if the Verification-of-Location data indicates that false points of the salted point cloud were tracked to, this may indicate that the Verification-of-Location data is being spoofed. Accordingly, by utilizing only a subset of the point cloud or a salted point cloud as the Proof-of-Location data, the system makes it more difficult for a user to spoof the Verification-of-Location data to provide a false-positive Proof of Location for the device.

In some examples, Proof-of-Location systems in accordance with aspects of the present teachings utilize on-device encryption as an anti-spoofing measure. For example, the user device may hash the Verification-of-Location data it generates and transmit the hash to a remote verifier, which compares the hash to a hash of the Proof-of-Location data. A match between the hashes comprises proof of the device's location. In some examples, a locality-sensitive hash method or a multi-index hash method is utilized to hash the Proof-of-Location and Verification-of-Location data, such that Proof of Location can be obtained even without an exact match between the Proof-of-Location data and Verification-of-Location data. Utilizing hashing makes it more difficult for a user to tamper with the generated Verification-of-Location data to generate a false-positive Proof of Location for the user.

In some examples, a CoreHash method is used for anti-spoofing. The CoreHash.compare method can determine whether two CoreHashes (e.g., a CoreHash of Proof-of-Location data and a CoreHash of Verification-of-Location data) are similar enough to constitute a match for proof of location. In some examples, a Bag of Words (BoW) creation algorithm is used to determine a measure of similarity or difference between Proof-of-Location and Verification-of-Location data. Some BoW examples may include additional or alternative metrics.

In some examples, anti-spoofing methods further include a Merkle tree (AKA a hash tree) and/or a TODA/IP protocol. A Merkle tree is a tree in which each node in the graph contains the hash of the sum of its children nodes. This makes it difficult to change one part of the tree without changing the entire tree, making the structure and data contained in the leaf nodes resilient against corruption and malicious attacks. TODA/IP is an internet protocol designed for peer-to-peer communication. In the TODA/IP protocol, hashes of the packets of data being transferred according to the protocol are constructed in a Merkle tree so that each packet can be verified without the use of certificate authorities. In some examples, communication between the user device and a remote verifier (or other user device providing verification in a peer-to-peer manner) is implemented using the TODA/IP protocol to help protect against attacks and/or other problems.

In some examples, anti-spoofing methods include a 2-step location verification sequence configured to provide improved confidence in establishing Proof of Location for the user at the location. The first step in the location verification sequence may include the server determining, based on the Verification-of-Location data generated by the user device at the location, that the user device appears to be at the location. The second step may include one or more hard-to-spoof tests for the user to perform at the location with the device. If the user passes the test(s), confidence in the verification of the user's location increases. The hard-to-spoof tests may be generated by the server or a third-party and sent to the user device. In some examples, the hard-to-spoof tests are randomly generated by the server and sent to the user device after the first step in the verification sequence is completed by the user. This would make it difficult for anyone attempting to spoof the data to anticipate the answer of the hard-to-spoof test. In some examples, the hard-to-spoof test has an expiration time before which the user must perform the test and provide the answer back to the server. This makes it difficult or practically impossible for the would-be spoofer to utilize brute force methods to solve the test, as the brute force methods would require too much time.

In some examples, the hard-to-spoof test comprises a randomized series of motions the user must perform in a certain time frame while the user device simultaneously captures a video or series of images at the location. For example, the test may include instructions directing the user of the device to move the device from an initial position upwards and to the left, upwards and to the right, to a neutral position, downwards and to the left, and back to the initial position. While the user moves the device as directed by the test, the user device may continuously scan the trackable feature at the location and generate corresponding data from the different orientations relative to the trackable feature. This data is sent to the server for analysis. Based on the test instructions transmitted to the user, data within certain ranges and/or having certain properties are expected and would be recognized as a correct result. If the data generated by the user device matches or approximates the expected correct result for the test, the server generates Proof of Location for the user at the location. The specific actions of the test would be very easy for a person onsite to perform, but the data generated by the device while the user performs the actions would be very difficult to replicate by a would-be spoofer at an off-site location.

In some examples, the 2-step location verification is utilized when the user device is a head-mounted display (HMD) worn by the user at the location. In some such examples, the hard-to-spoof test includes a series of head movements for the user to perform while wearing the head mounted display. For example, the test may direct the user to move their head to the right, to the center, to the left, upwards, and downwards. The head mounted display generates IMU data and/or optical data and sends the generated data to the server to be analyzed. If the data matches or approximates the expected data based on the specific test, the server provides Proof of Location for the user.

In some examples, the head-mounted display is configured to track the eye movement and gaze of the user of the device. In such examples, the hard-to-spoof test may include a series of letters or glyphs for the user to track with their gaze over a trackable feature in the environment at the location. For example, the user may be instructed to move their eyes such that their gaze traces a particular pattern in a brick wall or tiled floor, or such that their gaze traces over a particular portion of a city skyline. In some examples, the test directs the user to follow a point with their gaze as the point moves on the head-mounted display. The head-mounted display senses the path traced by the user's gaze using one or more suitable sensors. The sensed data is sent to the server for analysis. If sensed data indicates that the user's eye motions are within an acceptable range (e.g., that the sensed path of the user's gaze matches the instructed path within a certain tolerance), the server provides Proof of Location. In some examples, the head-mounted display additionally acquires image data of the environment (e.g., captured from the user's perspective) and transmits the acquired image data to the server so that the server can determine whether the acquired image data indicates that the user is, in fact, within view of the trackable feature at the location. This can help increase confidence in the Proof of Location.

In some examples, a process of obtaining Proof of Location in accordance with aspects of the present teachings includes requesting, utilizing a user's mobile device, Proof-of-Location data associated with a location the user claims to be at from a server and/or blockchain. The user device may receive the requested Proof-of-Location data from the server and/or from the Blockchain and capture a series of images or a video of the environment surrounding the mobile device utilizing a camera of the device. The Proof-of-Location data may include one or more feature “signals” or feature descriptors relating to a trackable feature at the location the device claims to be at. The images or video and the received Proof-of-Location data is then utilized by a software application of the device to generate Verification-of-Location data, as described above. In some examples, the generated Verification-of-Location data is communicated to a remote verifier (e.g., the server, a third party, etc.) configured to utilize the Verification-of-Location data to verify the user device is at the location the user claims to be at. This provides the remote verifier with proof that the device is in a particular location. In some examples, the software application stored on the user device includes one or more algorithms configured to verify the location of the user device based on the generated Verification-of-Location data. This provides the device itself with proof that the device is in a particular location. In some examples, the device is configured to communicate data related to this proof to another device.

In some examples, Proof-of-Location systems are implemented using a spatial blockchain. In some examples, an L−1 blockchain comprises a plurality of blocks each storing information relating to trackable data corresponding to a specific physical location on earth. Collectively, the blocks of the blockchain encompass the Earth, or a significant portion of the Earth (e.g., by including respective trackable data corresponding to each part of the globe, or a significant portion of the globe). A user may “win a block” by providing trackable data associated with a physical location on earth corresponding to a specific block in the blockchain. As an example, a user may scan a restaurant using their mobile device, in response to which the mobile device generates data relating to the restaurant as a trackable feature (e.g., a point cloud of a portion of the restaurant). The Proof-of-Location system (e.g., a server of the system and/or an application on the mobile device) may then be utilized to determine whether the trackable data generated is sufficient to be utilized to verify a future user's location at the restaurant (e.g., whether the trackable data is descriptive enough to permit another device to recognize the portion of the restaurant). If the Proof-of-Location system is sufficient, the trackable data is submitted to the blockchain and stored in the block associated with the location of the restaurant. In some examples, the user who generated the trackable data and submitted the data to the blockchain and thus “won” the block is given a reward for submitting the data (e.g., a cryptocurrency associated with the blockchain, a nonfungible token (NFT) associated with the block or the restaurant, a coupon redeemable at the restaurant, and/or any other suitable reward).

In some examples, a user device is configured to implement Proof-of-Location systems continuously in the background, without requiring user action to establish Proof of Location for the device. For example, the user device may be configured to automatically scan any nearby trackable features within a field of view of the device to establish Proof of Location for the device. If enough trackable features are present in the environment, this would allow the user device to perform many “location verification events” in which the user device utilizes the trackable features to establish Proof of Location for the device. The “location verification events” can be recorded by the user device to maintain a hard-to-spoof record of the movement of the device through space. IMU data and/or AI and machine learning techniques can be utilized to estimate the spatial position of the device in between the “location verification events.” In some examples, a plurality of user devices are each configured to implement Proof-of-Location systems continuously in the background. In such examples, each user device can continuously establish Proof of Location for itself and any nearby user devices. This would result in many hard-to-spoof “location verification events” that establish a record of the movement of each of the plurality of user devices through space. As described above, Proof-of-Location systems can be utilized to establish a record of an individual's movement through space that is far more difficult to spoof than GPS data and IMU data.

Aspects of Proof-of-Location systems may be embodied as a computer method, computer system, or computer program product. Accordingly, aspects of the Proof-of-Location system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the Proof-of-Location system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of Proof-of-Location systems may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C #, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the Proof-of-Location systems may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the Proof-of-Location systems. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative Proof-of-Location systems as well as related devices, systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Proof-of-Location Systems

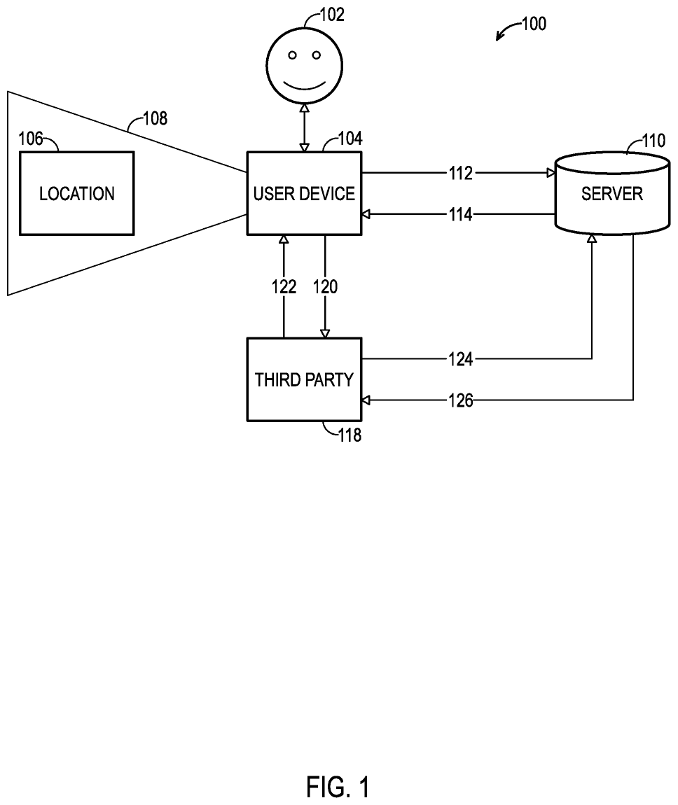

With reference to FIGS. 1-4, this section describes illustrative Proof-of-Location systems configured to generate Proof of Location for one or more users and/or user devices.

FIG. 1 depicts an illustrative Proof-of-Location system 100 allowing a single user to scan a location to generate data enabling Proof of Location. System 100 is an example of the Proof-of-Location systems described above.

As shown in FIG. 1, system 100 includes a user device 104 used by user 102. User device 104 may comprise any suitable mobile digital device (e.g., a smart phone) configured to be utilized by user 102 to image a location 106, where the user is located. The imaging device of mobile device 104 includes a field of view 108 that encompasses a portion of location 106. Although the depicted example shows only one user 102 and user device 104, in general system 100 may include a plurality of users 102 having respective user devices 104.

System 100 further includes a server 110, and a third-party system 118 (also referred to simply as the “third party”). Third-party system 118 may comprise any suitable data processing system operated by any suitable individual and/or entity (e.g., a company, an automated system, etc.) to which proof of the location of user 100 and/or user device 104 is relevant. In some examples, third party 118 may be a business or company that user 102 works for, another business, a bank, and/or any other suitable individual or company. For example, user 102 may be a package courier delivering a package for third party 118 at location 106.

User device 104, server 110, and third-party system 118 may each be configured to communicate with each other by any suitable method(s), such as via mobile network(s). As depicted schematically in FIG. 1, information 112 may be communicated by user device 104 to server 110, and information 114 may be communicated by server 110 to user device 104; information 120 may be communicated by user device 104 to third party 118, and information 122 may be communicated by third party 118 to user device 104; and information 124 may be communicated by third party 118 to server 110, and information 126 may be communicated by server 110 to third party 118. Although FIG. 1 depicts an example in which device 104, server 110, and third-party system 118 are each in two-way communication with each other, in some examples one or more of these two-way communications are instead one-way. For example, in some cases device 104 may be configured to receive information from third-party system 118 but not able to send information to third-party system 118.

System 100 may be utilized in a variety of different scenarios. For example, system 100 may be utilized to verify that user 102 has delivered a package to location 106 for third party 118. Server 110 communicates Proof-of-Location data to user device 104. Device 104 captures image data of location 106 and utilizes the Proof-of-Location data and captured image data to generate Verification-of-Location data configured to be utilized to verify the location of device 104. Device 104 communicates the Verification-of-Location data to server 110 and server 110 performs the verification to establish Proof of Location; server 110 may communicate information to device 104 and/or to third party 118 indicating that Proof of Location was (or was not) established. For example, user 102 may refrain from dropping off the package and leaving until they have received the message indicating that Proof of Location was successfully established. Additionally, or alternatively, third party 118 may refrain from acknowledging receipt of the package and/or paying for the package or delivery until third party 118 has received the message indicating establishment of Proof of Location. In some examples, a delivery business may offer this Proof-of-Location-enhanced delivery method to third party 118 as an upgrade to standard delivery service (e.g., for important packages).

In some cases, user device 104 and/or third party 118 may perform the verification instead of (or in addition to) server 110 performing the verification; however, verification by server 110 may be beneficial because depending on the scenario, user 102 or third party 118 may distrust that the other will accurately report the result of the verification attempt.

User device 104 is configured to receive Proof-of-Location data from server 110 and to generate Verification-of-Location data based on the Proof-of-Location data. For example, device 104 may be configured to execute one or more software applications configured to perform these functions. In this example, Proof of Location is established by having device 104 generate a point cloud of a trackable feature at location 106 and comparing the generated point cloud to a reference point cloud that a device truly located at location 106 is expected to be able to generate. For example, the reference point cloud may have been generated at location 106 at a previous time. Accordingly, the Proof-of-Location data comprises instructions and/or other suitable information configured to enable user 102 to generate a point cloud that matches the reference point cloud. For example, the Proof-of-Location data may comprise instructions or other information for the user as to how to generate the point cloud (for example, which trackable feature should be in the point cloud, where to stand and/or which direction to aim the field of view of the device in, and/or any other suitable information for enabling a user who is truly at location 106 to replicate the reference point cloud).

Generating Verification-of-Location data in this example comprises generating a point cloud based on the Proof-of-Location data. Generating a point cloud that matches the reference point cloud (e.g., within a predetermined tolerance) demonstrates that device 104 is close enough to the trackable feature in question to generate the point cloud and is therefore at location 106. The reference point cloud and associated Proof-of-Location data can be selected so as to determine how close to the trackable feature user 102 needs to be in order to replicate the reference point cloud and thus be deemed to be at location 106. In use cases in which it is desirable to prove that the user is in a specific, small area, it may be desirable to select a reference point cloud replicable only from a small area. For example, if the goal is to prove that the user delivered a package to a front door of a building, then the trackable feature may include a portion of a small sign on the door and the reference point cloud may be replicable only by a device located very near the door (e.g., with the user on the doormat). On the other hand, if the goal is simply to prove that the user was somewhere outside the building, then the trackable feature may be a portion of a façade of the building and the reference point cloud may be replicable by a device located anywhere on the same street block as the front door.

The Verification-of-Location data comprising the point cloud generated by device 104 is communicated by device 104 to server 110. Server 110 is configured to verify the location of user device 104 by comparing the generated point cloud to the reference point cloud. If the reference point cloud and generated point cloud match based on predetermined criteria, server 110 determines that the location of user device 104 has been verified. Determining a successful verification may be referred to as establishing Proof of Location, and communicating information conveying the establishment of Proof of Location may be referred to as providing Proof of Location. For example, in this case server 110 may be configured to provide Proof of Location to third party 118 (who may, e.g., have hired user 102 to deliver a package to location 106 and infers from the Proof of Location that user 102 did deliver the package) and/or to user 102 (who may, e.g., wish to use the Proof of Location to protect themselves against later allegations that they failed to deliver the package).

In the example described above, the Verification-of-Location data comprises a point cloud generated by the user device and the Proof-of-Location data comprises data configured to facilitate the user device generating the point cloud based on the user device truly being at the location in question. However, other suitable examples of Verification-of-Location and Proof-of-Location data can be used in system 100. For example, the Proof-of-Location data may comprise data identifying a trackable feature of the location (e.g., a reference point cloud) and the Verification-of-Location data may comprise data generated based on the device attempting to track to the trackable feature (e.g., to relocalize to the reference point cloud, in which case the data generated based on the tracking attempt may include data about which points of the cloud were tracked to, how many times each point was tracked to, how frequently each point was tracked to, and/or any other suitable data).

Optionally, the Proof-of-Location data received by device 104 may include data configured to facilitate anti-spoofing techniques. In some examples, the Proof-of-Location data communicated by server 110 to user device 104 includes a mask configured to be applied to field of view 108 of user device 104 and/or to any images or video feed captured by user device 104. As described elsewhere herein, the mask may comprise a software mask configured to algorithmically remove the image data corresponding to a particular portion of the field of view, and/or a hardware mask configured to physically block a particular portion of the field of view. The mask may be utilized as an anti-spoofing measure to increase the difficulty of generating fake Verification-of-Location data that produces a false positive Proof of Location result. In some examples, user 102 is directed to place the package being delivered such that the package masks a portion of the trackable feature. For example, the Proof-of-Location data may direct the user to place the package on a doormat, where it obscures part of the trackable feature (which may be, e.g., the doormat, a portion of scenery behind the doormat, etc.).

In some examples, the Proof-of-Location data received by user device 104 includes instructions for user 102 to follow to generate the Verification-of-Location data in a specific manner configured to make successful spoofing difficult. An example instruction is an instruction to place the package at location 106 prior to capturing the images or video of the location with user device 104 (e.g., using the package as a mask). As another example, the Proof-of-Location data may direct user 102 to move in a specific manner while capturing a video of location 106 with user device 104 (e.g., to scan the image sensor of the device over a particular region of the location and/or to image the location from a particular vantage point). Having the user move while capturing the video of location 106 may increase the difficulty for the user to spoof the generated Verification-of-Location data, because it is unlikely that the would-be spoofer can falsely generate video data matching the video data that would be captured as the user moves in the directed manner. In some examples, instructions to the user have a randomly generated component for further anti-spoofing. For example, the user may be directed to move their device according to a randomly generated pattern.

The above example refers to an illustrative use case for system 100 in which user 102 is delivering a package to location 106 and third party 118 desires Proof of Location of the user at that location. In general, however, system 100 may be used to establish Proof of Location in any suitable context. Illustrative non-limiting examples are described below.

In some examples, system 100 provides Proof of Location to user 102 and not necessarily (or at all) to any third-party system 118. This may be the case if, e.g., user 102 wishes to have a record that they delivered a package to location 106 or that they were at location 106 to provide a service (e.g., in-home health care, pet-sitting, home maintenance, etc.).

In some examples, system 100 is used to facilitate user 102 unlocking a door, container, or other suitable access point at location 106 only if Proof of Location is established. For example, in response to establishing that user 102 is at location 106, server 110 (or another device in communication with the server) may transmit a passcode to user device 104, remotely unlock an electronic lock, enable a user interface of a data processing system at location 106, and/or take any other suitable action. System 100 may be used in this manner to provide a secure locker, mailbox, home security system, short term vacation rental, hotel, banking machine (e.g., ATM), and/or for any other suitable application.

Proof of Location generated by system 100 may be utilized in various different scenarios in which a user 102 is required or desired to prove to a third party 118 that the user is at a specific location at a specific time. For example, system 100 could be utilized by businesses to verify that remote workers are at their home work stations ready to work at specified times throughout the workday (e.g., at the start of the workday, every hour, etc.). In such examples, user 102 is the remote worker and third party 118 may be the remote worker's supervisor and/or other interested individuals. The remote worker generates Verification-of-Location data by tracking to a trackable feature in their home office (e.g., a portion of a desk, chair, etc.), and server 110 verifies, based on data associated with the tracking, that the worker was in the location. A notification may then be sent to the remote worker's supervisor indicating that the remote worker established Proof of Location at their home office space. In these examples, any suitable method(s) may be used to determine that the worker is not merely in the expected place but is there at the correct time. This would avoid a scenario in which the user pre-generates and stores point clouds of various features of their home office space usable to spoof the system. For example, the data associated with tracking to the trackable feature may include timestamps or WGS coordinates of the tracking. As another example, the worker may generate the Verification-of-Location data in response to receiving Proof-of-Location data from server 110, and the Proof-of-Location data may include instructions that are hard to predict in advance, such as instructions to the user to move their device in a particular (in some cases, randomized) motion pattern while acquiring image data.

Similarly, system 100 may be utilized by schools to verify that students attend their classes throughout the day.

In some examples, third party 118 establishes a trackable feature at location 106 that may be utilized to establish Proof of Location for individuals at location 106 (e.g., individuals delivering packages to location 106). In such examples, third party 118 may be a worker at an office who establishes a trackable at the office (e.g., a point cloud of a portion of the front desk or front door of the office). To increase confidence in the newly established trackable, other employees who work in the office could establish their own Proof of Location by using their respective devices to relocalize to the point cloud of the trackable feature. After enough individuals utilize the trackable to establish Proof of Location, the trackable feature would be deemed trusted for proving that an individual is at the office. For example, tach time a package is delivered to the office, the individual that delivers the package would then be able to utilize the trusted trackable to prove that they were at the office and delivered the package.

Proof of Location generated by system 100 may utilized to facilitate user 102 signing into a building (e.g., an office, gym, apartment, school, AirBnB short term rental home, retail store, etc.) at location 106. For example, user 102 may establish Proof of Location for themselves at the building at location 106 by tracking to a trackable feature (e.g., a portion of the front door, front desk, etc.) of the building. A notification of the established Proof of Location of user 102 at the building could then be sent to a third party 118 (e.g., building owner, business owner, etc.) interested in having a record of the individuals who have entered the building.

In some examples, the Proof of Location generated by system 100 may be utilized to grant or deny individuals access to a building. For example, rather than having a keypad door lock on an apartment building or office door, the building or office requires an individual to establish Proof of Location at the building or office to unlock the door. Access would only be granted to specific user devices of individuals that are meant to have access to the building (e.g., employees at the office, residents of the apartment building, etc.). In another example, a key to an AirBnB rental home may be stored in a lockbox that is unlocked when an individual who has booked a stay at the AirBnB rental home establishes Proof of Location at the rental home. Utilizing Proof of Location to grant or deny individuals access to a building provides improved security in comparison to keypad door locks which have combinations that can be easily shared, stolen, or guessed.

In some examples, Proof of Location system 100 is utilized as an alternative to ankle monitors for individuals under house arrest. In such examples, user 102 is under house arrest and is required to remain at the user's home. User 102 receives notifications on user device 104 instructing user 102 to take a photograph of themselves (e.g., a selfie) in front of a trusted trackable background in the user's home. These notifications may be sent recurrently (e.g., every hour) to user device 104 and the photos are utilized by user device 104 to generate Verification-of-Location data configured to prove that user 102 was at their home at the specific time. Inertial measurement unit (IMU) data recorded by user device 104 may additionally be utilized to track the user's movement between the instances when the user establishes Proof of Location at the home. A notification indicating the established Proof of Location may be sent (in some cases, along with the IMU data) to a relevant third party (e.g., a law enforcement officer).

In some examples, mobile apps on user device 104 utilize Proof of Location system 100 to provide user 102 with rewards associated with visiting specific locations. For example, user 102 may establish Proof of Location at location 106 by tracking to a trusted trackable feature at location 106 using user device 104. In response to user 102 proving they are at location 106, the mobile app provides user 102 with notifications recommending nearby restaurants or retail stores, discounts or offers at nearby stores, etc. In some examples, having users repeatedly track to trackable features helps to increase confidence in the trackability of the feature and/or the geographic location of the feature, so incentivizing many users to track to many features facilitates development of a trusted system of trackable features.

Proof of Location system 100 may be utilized by businesses to identify customers and prevent giving a customer's private data to the wrong person. For example, a bank, doctor's office, and/or any other suitable business or other entity may require that the customer establish Proof-of-Location at the customer's home prior to providing the customer with private information. In other words, Proof of Location established by system 100 can prove a customer's identity by proving that the customer is at a location that only that customer would have access to (e.g., a room in the user's house).

Similarly, Proof-of-Location system 100 may be utilized to verify that user 102 lives at a residence. For example, user 102 may be required to generate Proof of Location at the residence by scanning to a trusted trackable feature at the residence. In some examples, the trusted trackable feature is inside the residence, such that only someone who actually lives at the residence would have access to the trackable feature. In some examples, user 102 is required to generate Proof of Location at the residence multiple days in a row.

In some examples, Proof-of-Location system 100 is utilized by services that conventionally rely on GPS (or other WGS systems) to establish Proof of Location for users of the service. Proof of Location established by system 100 is difficult to spoof in comparison to GPS data, and therefore increases confidence in the generated Proof of Location. This would allow rewards associated with users generating Proof of Location in specific locations to be of higher value. For example, in-game rewards for location-based games (e.g., Pokemon GO) are associated with players visiting specific locations. The location-based games may require that the player generate Proof-of-Location by tracking to a trackable feature to receive the reward associated with the location. In another example, Uber, Lyft, and other ride-sharing services may require that individuals generate Proof of Location at the pickup location. This would stop users from lying about their location to receive favorable rates. In another example, retail stores offer a sale to individuals that establish Proof of Location at the retail store by tracking to a trackable feature, such as a portion of the front door or front counter of the store.

Proof of Location established by system 100 may be utilized to facilitate a mobile transaction of money or other valuable items in a lockbox that is simplified in comparison to an ATM. For example, user 102 sends a request to a business, friend, bank, and/or any other suitable entity indicating that they wish to come pick up a certain amount of cash or a valuable item (e.g., at a specified time). The receiver of the request inserts the money or specified valuable item into a lockbox or other suitable mechanism. User 102 is notified of the location of the lockbox (which may be stationary or may have been transported to a location near user 102 in response to the request). User 102 goes to the lockbox (unless already there, e.g., because the lockbox was brought to the user's location) and establishes Proof of Location by utilizing user device 104 to scan the lockbox and/or another trackable feature at the location. The lockbox is unlocked in response to user 102 proving user 102 is at the location of the lockbox. The above-described method reduces the infrastructure and electronics required for ATMs by allowing the transaction of money with the use of a lockbox.

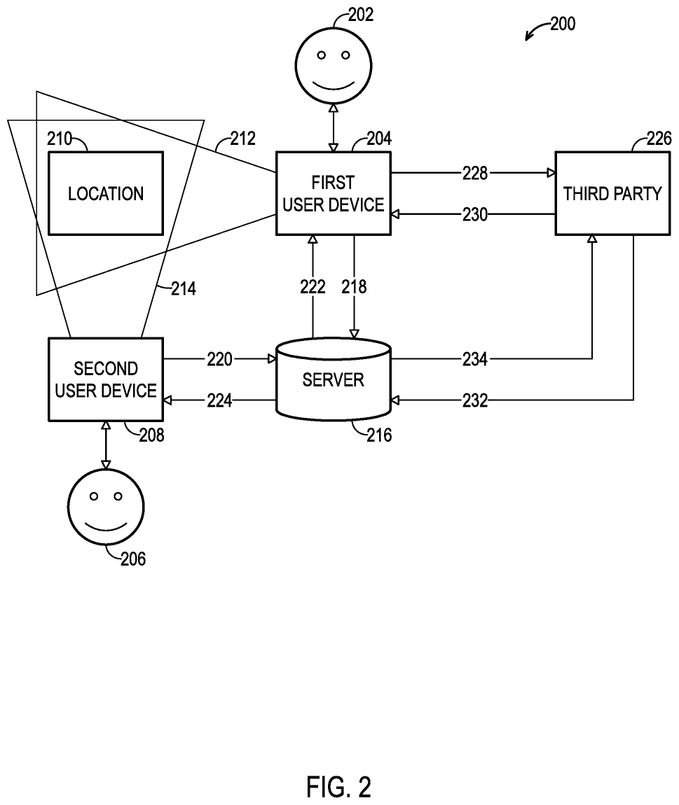

Turning now to FIG. 2, FIG. 2 depicts a Proof-of-Location system 200 wherein multiple users (in this example, first user 202 and second user 206) scan a location to generate and verify Proof of Location, either for themselves, a remote server, or a third party. Proof-of-location system 200 includes a first user device 204 used by first user 202 and a second user device 208 used by second user 206. First user device 204 and second user device 208 may each comprise any suitable mobile digital device configured to capture images and/or video of a location 210. First user device 204 includes a first field of view 212 directed toward location 210 and second user device 208 includes a second field of view 214 directed toward location 210.

Both first user device 204 and second user device 208 are in communication with a server 216, such that information (218 and 220) may be communicated by user devices 204 and 208 to server 216. Server 216 may communicate information (222 and 224) to first user device 204 and second user device 208. The information communicated by server 216 to first user device 204 and second user device 208 may include Proof-of-Location data (e.g., a point cloud of a trackable feature, identification of a location to generate a point cloud of, a mask to apply to field of views 212 and 214 of user devices 204 and/or 208, etc.), a notification confirming verification of the location of one or both of the users, and/or any other suitable information. The information communicated by first user device 204 and second user device 208 to server 216 may include Verification-of-Location data (e.g., images, generated point clouds, point cloud relocalization-related data, etc.) generated by the user device, and/or any other suitable information.

Information may be communicated between the user devices and server 216 via any suitable method, such as a mobile network.

In some examples, first user device 204 is in communication with a third-party system 226 (also referred to as third party 226), such that information 228 may be communicated by first user device 204 to third party 226 and information 230 may be communicated by third party 226 to first user device 204. Information 228 communicated by first user device 204 to third party 226 may include confirmation information relating to Proof of Location for first user 202, first user device 204, second user 206, and/or second user device 208 at location 210. Third party 226 may include any individual(s) to whom Proof of Location for first user 202, first user device 204, second user 206, and/or second user device 208 is relevant. In some examples, third party 226 is in communication with server 216, such that information 232 may be communicated by third party 226 to server 216 and information 234 may be communicated by server 216 to third party 226. In some examples, third-party system 226 is omitted.

Proof-of-Location system 200 may be utilized for many different purposes. For example, first user 202 may order a package to be delivered by second user 206 to location 210. In such examples, Proof-of-Location system 200 is utilized to provide Proof of Location of second user 206 when the second user delivers the package to location 210. In some examples, first user 202 scans location 210 using first user device 204 to generate one or more images or a video feed of location 210. First user device 204 includes one or more software applications configured to receive the images or video feed of location 210 and generate Proof-of-Location data (e.g., a point cloud) relating to one or more trackable features disposed at location 210. The Proof-of-Location data generated by first user device 204 is then communicated to server 216. (In some examples, the first user device uploads the images or video to the server and the Proof-of-Location data is generated at the server based on the images or video, rather than at first user device 204.) The second user goes to location 210 to deliver the package and server 216 communicates the Proof-of-Location data generated by the first user device to second user device 208. The second user utilizes second user device 208, based on the Proof-of-Location data, to scan location 210 to generate one or more images or a video feed of location 210 and second user device 208 generates, based on the images or video feed, Verification-of-Location data (e.g., a point cloud to be compared to a point cloud generated by the first user, a point cloud of a location specified by the first user, etc.). The Verification-of-Location data generated by second device 208 is communicated to a remote verifier (e.g., server 216) and server 216 utilizes the Verification-of-Location data to establish Proof of Location for second user 206.

Server 216 optionally sends a notification to second user device 208 indicating that Proof of Location has been established. In response to this notification, second user 206 may drop off a package and leave, and/or take any other suitable action. Alternatively, or additionally, the server notifies the first user that Proof of Location has been established for the second user.

Second user device 208 and/or server 216 may utilize any of the methods described herein to establish Proof of Location for second user 206 at location 210. In some examples, establishing Proof of Location includes utilizing one or more algorithms to compare the Verification-of-Location data generated by second user device 208 to the Proof-of-Location data generated by first user device 204 and/or to data associated with the Proof-of-Location data. In some examples, the Proof-of-Location data generated by the first user device includes a point cloud of a trackable feature at location 210 (and/or includes information or instructions configured to allow another device at the location to attempt to replicate the point cloud), and the Verification-of-Location data generated by the second user device includes a point cloud generated by the second user device at the location (e.g., a point cloud of the same trackable feature, configured to replicate the first user's point cloud as closely as possible). In such examples, generating Proof of Location includes utilizing one or more algorithms to determine whether the point cloud generated by the first user device and the point cloud generated by the second user device are identical (e.g., practically identical, cryptographically indistinguishable, and/or identical to any other suitable degree). If the point clouds are identical (or sufficiently close to identical), it is proven that the second user was at the same location at which the first user generated the point cloud, because both user devices were in view of the same trackable feature in a manner allowing them to generate identical point clouds of the feature.

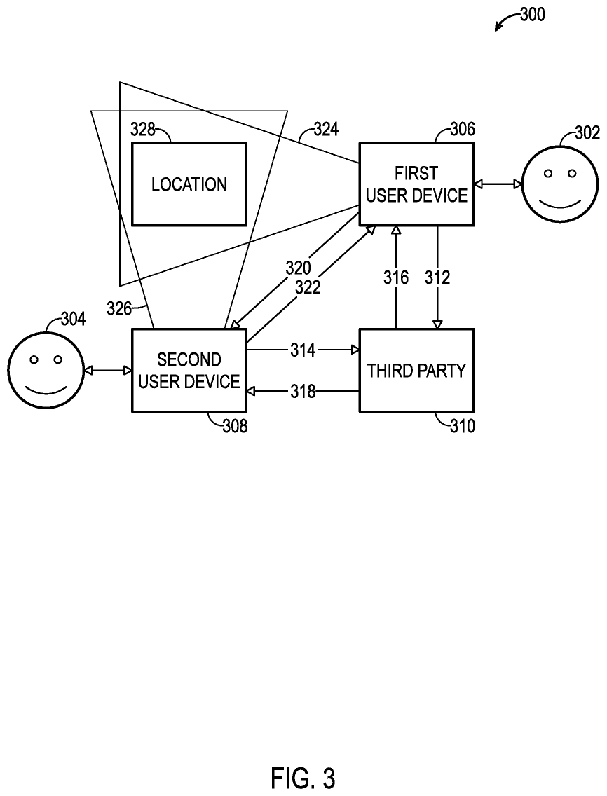

FIG. 3 depicts a Proof-of-Location system 300, wherein a first user 302 can generate or verify Proof-of-Location data of a second user 304 in a peer-to-peer manner, without the use of an intermediary server to perform the verification. As shown in FIG. 3, system 300 includes a first user device 306 used by first user 302 and a second user device 308 used by second user 304. First user device 306 and second user device 308 are in communication with a third-party system 310 (referred to also as “third party 310”), such that information (312 and 314) may be communicated by the first and second user devices to third party 310, and information (316 and 318) may be communicated by third party to the first and second user devices. First user device 306 and second user device 308 are also in communication with each other, such that information 320 may be communicated by first user device to second user device 308 and information 322 may be communicated by second user device 308 to first user device 306.

First user device 306 and second user device 308 may comprise any suitable mobile digital device (e.g., smart phone) configured to capture images and/or video of an environment surrounding the device. As shown in FIG. 3, first user device 306 and second user device 308 each have a respective field of view (324 and 326) directed toward a location 328. Both the first and second user devices include one or more software applications having computer vision algorithms configured to generate Proof-of-Location data and/or Verification-of-Location data relating to location 328.

Proof-of-Location system 300 may be utilized for a variety of different purposes. For example, Proof-of-Location system 300 may utilize peer to peer verification, wherein first user 302 verifies the location of second user 304 for third party 310 (e.g., because second user 304 is delivering a package to third party 310 at location 328, and/or for any other suitable reason). Second user 304 goes to location 328 and utilizes second user device 308 to generate suitable data (e.g., a point cloud of a trackable feature at location 328). Second user device 308 may then communicate the generated data to third party 310 and/or directly to first user 302. In examples in which the generated data is communicated to the third party, the third party communicates the generated data to first user 302. Communicating the generated data from the second user device to the third party rather than directly to the first user may allow the third party to stay informed as to the progress of the delivery or other process and/or to abort the process if desired (e.g., if the generated data indicates some kind of problem).

Based on receiving the data generated by second user device 308, first user 302 may go to location 328 and utilize the generated data to verify that the second user was at location 328. In some examples, verifying that the second user was at location 328 includes the first user 302 attempting to prove that they are at location 328 using the generated data as though it were trusted to represent location 328. For example, the generated data may be a point cloud generated by the second user when they were purportedly at location 328, and the first user may attempt to relocalize at location 328 using that point cloud as though it were a trusted reference point cloud. Alternatively, or additionally, the first user may generate their own point cloud and determine whether it corresponds sufficiently to the second user's point cloud (or transmit it to the third party for the third party to make the determination). If the first user can successfully establish their own Proof of Location at location 328 utilizing the data generated by the second user device, this amounts to verification that the second user was at location 328. In response to receiving notification that their own Proof of Location was established, first user 302 notifies third party 310 that the second user's location is verified.

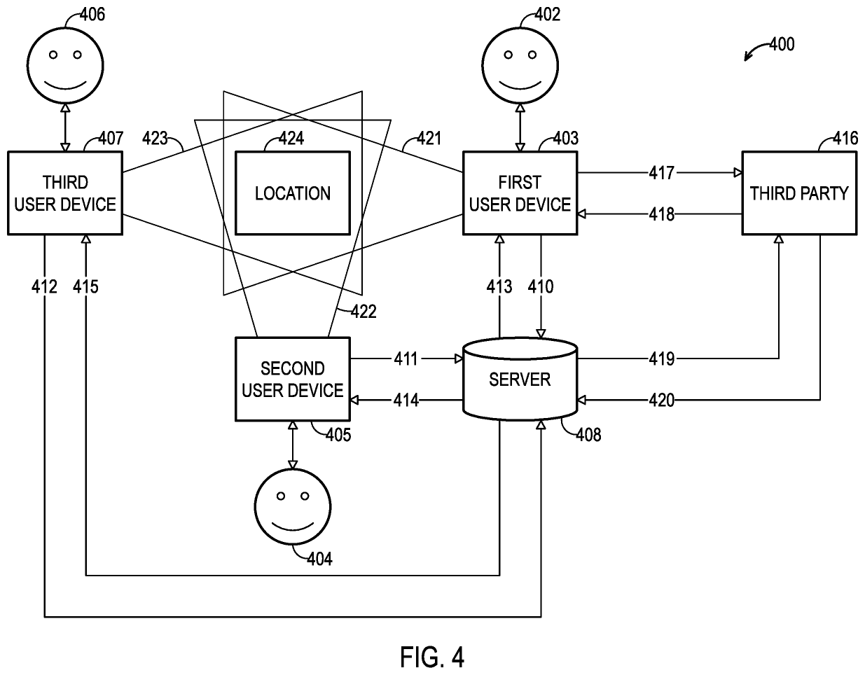

FIG. 4 depicts an illustrative Proof-of-Location system 400 allowing three users to generate and/or verify Proof-of-Location data, e.g., for themselves, a server, and/or a third party. As shown in FIG. 4, Proof-of-Location system 400 includes user devices 403, 405, 407 (e.g., smart phones) used by users 402, 404, 406. Each user device (403, 405, and 407) is in communication with a server 408, such that information (410, 411, and 412) can be communicated from the user devices to server 408, and information (413, 414, and 415) can be communicated from server 408 to each of the user devices. First user device 403 is in communication with a third party system 416 (also referred to simply as third party 416), such that information 417 can be communicated from first user device 403 to third party 416, and information 418 can be communicated from third party 416 to first user device 403. In some examples, server 408 and third party 416 are in communication with each other, such that information 419 can be communicated from server 408 to third party 416 and information 420 can be communicated from third party 416 to server 408. Each user device (403, 405, and 407) has a respective field of view (421, 422, and 423) directed toward a location 424.

Proof-of-Location system 400 can be utilized for a variety of different purposes. For example, suppose first user 402 wants a package to be delivered by second user 404 to location 424. In such examples, Proof-of-Location system 400 utilizes third user 406 to verify the location of second user 404 when the second user is at location 424 delivering the package. First user 402 may communicate GPS coordinate data, an address, and/or Proof-of-Location data (e.g., a reference point cloud) relating to location 424 to server 408 utilizing first user device 403. Server 408 communicates the GPS coordinate data, address, and/or Proof-of-Location data to second user device 404, and based on the communicated data, second user goes to location 424 to deliver the package. When second user 404 arrives at location 424, the second user utilizes second user device 405 to scan location 424. Second user device 405 includes one or more software applications configured to generate Verification-of-Location data (e.g., a point cloud of a trackable feature at location 424) relating to location 424. In some examples, second user 404 is directed (e.g., by the data communicated from server 408 and/or by other suitable information) to scan a specific target area of location 424 to generate Verification-of-Location data corresponding to location 424. In some examples, second user 404 is directed to place the package at location 424 and scan location 424 utilizing the package as a mask. The generated Verification-of-Location data is communicated by second user device 405 to server 408.

Third user 406 then goes to location 424 (e.g., because they were previously instructed to go there, in response to a message communicated by server 408 to third user device 407, which may include the GPS coordinate data and/or address of location 424, in response to a message delivered by other means, and/or on any other suitable basis). When third user 406 is at location 424, the third user utilizes third user device 407 to scan location 424 and generate Verification-of-Location data (e.g., a point cloud of a trackable feature at location 424). The Verification-of-Location data generated by third user device 407 is sent to server 408. Server 408 utilizes one or more Proof of Location methods to compare the Verification-of-Location data generated by the second user device 405 to the Verification-of-Location data generated by the third user device 407. If the comparison indicates that the Verification-of-Location data generated by second user device 405 matches that generated by third user device 407, the system concludes that second user device 405 was at location 424, indicating that the second user likely did deliver the package to location 424. Server 408 may notify first user 402 that the package has been delivered to location 424.

In some examples, third user 406 is already at location 424 and therefore does not need to go there in order to generate Verification-of-Location data. In some examples, third user 406 generates their Verification-of-Location data before and/or at approximately the same time that second user 404 generates theirs (e.g., third user 406 may go to the location before user 404 does or approximately at the same time that user 404 does).

In some examples, Proof-of-Location system 400 is utilized to sell data for Proof of Location and/or to sell the service of providing such data. For example, first user 402 may scan location 424 utilizing first user device 403 to generate a point cloud of a trackable feature at the location, or other suitable information associated with the location. First user 402 may upload the generated information to server 408 along with GPS coordinates corresponding to location 424. In some examples, first user 402 also uploads information to become part of Proof-of-Location data configured to facilitate a user establishing Proof of Location. For example, if the first user had generated a point cloud of the location, they may upload the point cloud along with information designed to help another use replicate the point cloud at the location (e.g., instructions on which feature to generate the cloud of, on where to stand or aim the camera, etc.). Second user 404, who wishes to have a package delivered to location 424, may purchase Proof-of-Location data based on the data uploaded to server 408 by first user 402. The system may be configured such that the second user purchases the Proof-of-Location data from first user 402 (e.g., entering into a transaction with first user 402 to obtain authorization to download the Proof-of-Location data from the server), and/or such that the second user purchases the uploaded data from an entity operating the server. In some cases, the server has a plurality of sets of Proof-of-Location data uploaded by a plurality of users.

In some examples, after purchasing the Proof-of-Location data, second user 404 hires third user 406 to deliver a package to location 424. The Proof-of-Location data relating to location 424 can then be communicated by server 408 to third user device 407. When third user 406 arrives at location 424, third user 406 utilizes third user device 407 to capture images or a video feed of location 424. Third user device 407 includes a software application configured to utilize the captured images or video feed to generate Verification-of-Location data based on the received Proof-of-Location data. The Verification-of-Location data is sent to server 408 to be utilized by server 408 to verify the location of third user 406 (e.g., based on the point cloud and/or other data uploaded by the first user). After the third user's location is verified, server 408 may notify second user 404 that the third user's location was verified and/or that the package was delivered to location 424.

In some examples, the service provider that sells the Proof-of-Location data to the second user also facilitates the second user's hiring of the third user. For example, the service provider may provide a website or app that facilitates both purchase of the data and hiring of a courier (or other worker) who will perform a delivery (or other task) using the purchased data. In some examples, the service provider does not directly facilitate hiring of the third user but does facilitate the third user downloading the purchased data from the server, rather than requiring the second user to download the data and provide it to the third user. In some examples, the service provider does not facilitate the third user downloading the data directly and it is necessary for the second user to download the data and provide it to the third user.

In some examples, second user 404 may hire third user 406 to deliver the package and third user 406 may purchase the Proof-of-Location data, rather than the second user purchasing the data. For example, the third user may wish to have proof that they successfully delivered the package and therefore may purchase the Proof-of-Location data. Accordingly, either the hirer (i.e., second user 404) or the hired worker (i.e., third user 406) or both the hirer and hired worker can purchase the Proof-of-Location data corresponding to location 424 that was acquired by first user 402.

### B. Illustrative Proof-of-Location System Utilizing a Ledger

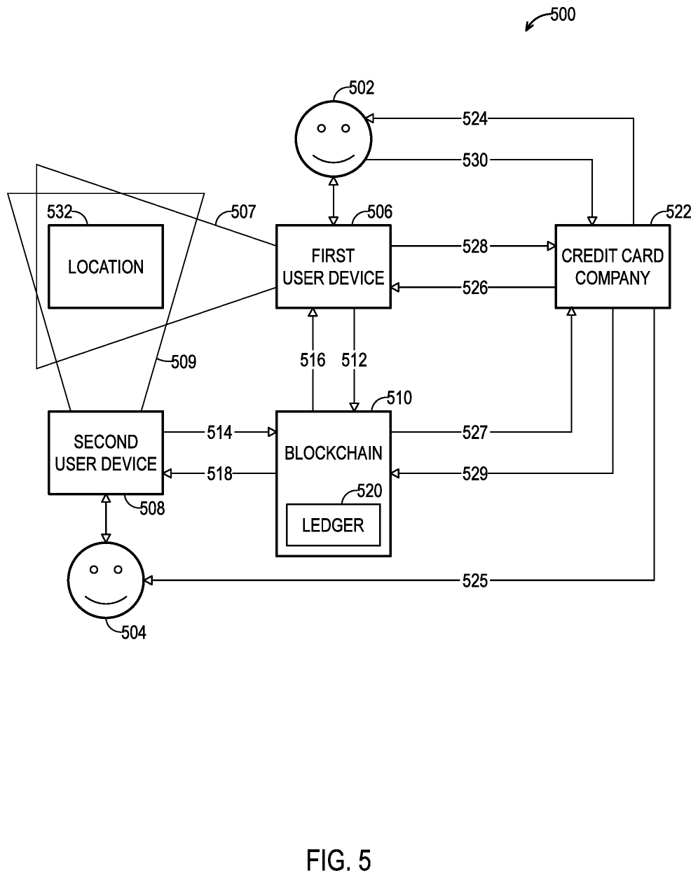

As shown in FIG. 5, this section describes an illustrative Proof-of-Location system 500 configured for implementing Proof of Location in conjunction with a ledger, in this example implemented via blockchain. In some examples, Proof-of-Location system 500 is used to verify a first user's location “after the fact” (e.g., to verify that the user was at a particular location at a past time), either directly (e.g., directly verifying Verification-of-Location data provided by the first user) or indirectly (e.g., with a second user verifying Verification-of-Location data generated by the first user). In some examples, Proof-of-Location system 500 is utilized to evaluate suspected fraudulent purchases made on the first user's credit card. For example, system 500 may be used to establish that the first user was at a first location at the time a disputed purchase was made at a second location different from the first location, thus showing that the purchase was not made by the first user.

Proof-of-Location system 500 includes a first user device 506 and second user device 508, used by a first user 502 and a second user 504 respectively. Each user device (506 and 508) has a respective field of view (507 and 509) aligned with a location 532. Each user device (506 and 508) is configured to communicate with a blockchain system 510, such that information (512 and 514) may be communicated by the user devices to blockchain 510, and user devices (506 and 508) may receive information (516 and 518) from blockchain 510. Blockchain 510 comprises a distributed ledger 520 configured to store information relating to specific locations at which different users were located at specific times. In some examples, such as those described below, information (512 and 514) communicated by the user devices to blockchain 510 may include data relating to Proof of Location for the user device (e.g., at specific time(s)).

System 500 further includes a computing system 522 operated by a credit card company. Credit card company system 522 (also referred to simply as the credit card company or “the company”) is in communication with first user device 506, such that information 526 may be communicated from the company to the first device and information 528 may be communicated to the company from the first device. Credit card company 522 is in communication with blockchain 510 such that credit card company 522 has access to the Proof-of-Location data (e.g., user-specific Proof-of-Location data) stored in ledger 520 of blockchain 510. Credit card company 522 is configured to receive information 527 from blockchain 510 and send information 529 to blockchain 510.

In some examples, Proof-of-Location system 500 is utilized by credit card company 522 to determine whether first user 502 was at a particular location at a particular time. Proof that the first user was at a first location at a particular time may be interpreted as proof that the first user was not elsewhere (e.g., at a second location) at that time and thus may serve as an alibi for the first user.

As an example, first user 502 may utilize first user device 506 to generate Verification-of-Location data indicating that first user 502 is at a first location 532 at a first specific time A. Suitable Verification-of-Location data may include, e.g., a point cloud of a feature of location 532 and/or any other suitable verification data. In some cases, the Verification-of-Location data further includes a timestamp indicating the time and/or date at which the point cloud was generated, image information reflecting time and/or date (for example, color and/or light intensity information indicating low daylight or strong daylight or the presence or absence of shadows in particular places). Alternatively, or additionally, the Verification-of-Location data may inherently reflect a date or time. For example, the data may comprise a point cloud including a face of a clock, a beacon signal known to be generated at a particular time, and/or any other suitable indication of day or time. The generated Verification-of-Location data is communicated from first user device 506 to blockchain 510 and stored in ledger 520.

At a second time B, which is after first time A, first user 502 receives a notification from credit card company 522 (e.g., on first user device 506 and/or by another suitable channel, such as a phone call on a different device, indicated in FIG. 5 as channel 524) indicating that the first user's credit card was used to make a purchase somewhere other than location 532 (e.g., at a second location) at the first time A. In response, first user 502 notifies credit card company 522 that first user 502 did not make the purchase at the second location at time A. The notification may be made using user device 506 and/or another suitable channel, indicated in FIG. 5 as 530. Credit card company 522 then receives from blockchain 510 the Verification-of-Location data generated by first user device 506 at location 532 at time A and uses the Verification-of-Location data to establish Proof of Location that the first user was indeed at location 532 at time A and thus could not have made the purchase at the second location.

In some examples, company 522 compares the Verification-of-Location data generated by first user device 506 at location 532 to previously generated Verification-of-Location data associated with location 532 to verify the location of first user 502 at location 532 at time A. For example, the Verification-of-Location data generated by first user device 506 at time A may include a first point cloud of a trackable feature disposed at location 532, and the company may compare the first point cloud to a second point cloud previously generated at the location. The second point cloud may be stored at any suitable memory device (e.g., a memory store of the company's computing system, blockchain system 510, a database of point clouds stored by a Proof-of-Location service provider, and/or any other suitable memory storage). A sufficient match between the first point cloud and the previously generated second point cloud may be interpreted as verification that the first user was at location 532 at time A (and therefore could not have been at the second location at time A).

In some examples, in response to the purchase made using the first user's card, the credit card company compares the first user's point cloud (or other suitable Verification-of-Location data) to the previously generated second point cloud (or other suitable reference Proof-of-Location data) without waiting for the first user to assert that they did not make the purchase. For example, this may be a service offered by the company to users who wish to have all transactions (or a certain category of transactions, like those over a threshold amount of money) verified in this manner.

In some examples, no reference Proof-of-Location data is available for first location 532, or the reference data is available but additional verification is desired anyway. In such examples, credit card company 522 may cause second user 504 to go to first location 532 and utilize second user device 508 to generate Verification-of-Location data at first location 532 at a third time C later than time B. Second user 504 may be, e.g., an employee of the company, an individual hired by the company to perform the task, another customer of the company doing the task for a reward, an autonomous drone, and/or any other suitable person or device. The company may instruct the second user to go to the location and generate the data by communicating with the second user via second user device 508 and/or via another suitable communication channel, indicated in FIG. 5 as 525.

The Verification-of-Location data generated by second user 504 at first location 532 at third time C may then be compared to the Verification-of-Location data generated by the first user device at time A. A sufficient correspondence between the first user's Verification-of-Location data and the second user's Verification-of-Location data establishes Proof of Location of the first user at location 532 at time A.

In response to obtaining Proof of Location for first user 502 at time A at location 532, the company may conclude that first user 502 did not perform the credit card transaction at a different location at time A, and take a suitable action (e.g., canceling the transaction, investigating the fraud, canceling the credit card, and/or any other suitable action). First user 502 may use first device 506 to generate Verification-of-Location data and store it in the blockchain at any suitable time(s). For example, the user may generate and store the data each time they arrive at a new location, when they arrive at a particular location, at predetermined time intervals, in response to prompts from company 522, and/or on any other suitable basis. In some cases, first user device 506 is configured to automatically generate and upload the data (e.g., at predetermined intervals, in response to prompts from company 522, based on location of the device, etc.). For example, a plurality of beacons configured to broadcast identifiable signals may be distributed throughout a geographic area, and the device may be configured to upload data to the blockchain indicating which signals it has received at which times.

System 500 is described in this section in the context of a credit card transaction, but in general, examples of system 500 can be used in any suitable context in which establishing Proof of Location for a user at a specific time and place can serve as proof (or at least, as an indication) that the user was not at a different place at that time.

### C. Illustrative Proof-of-Location System for User Authentication

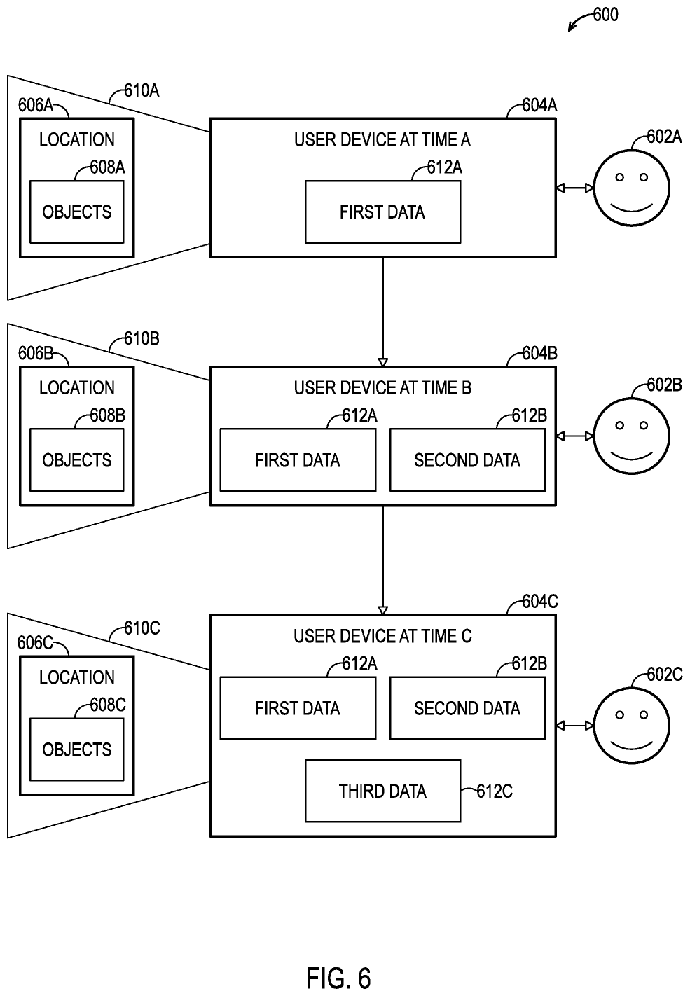

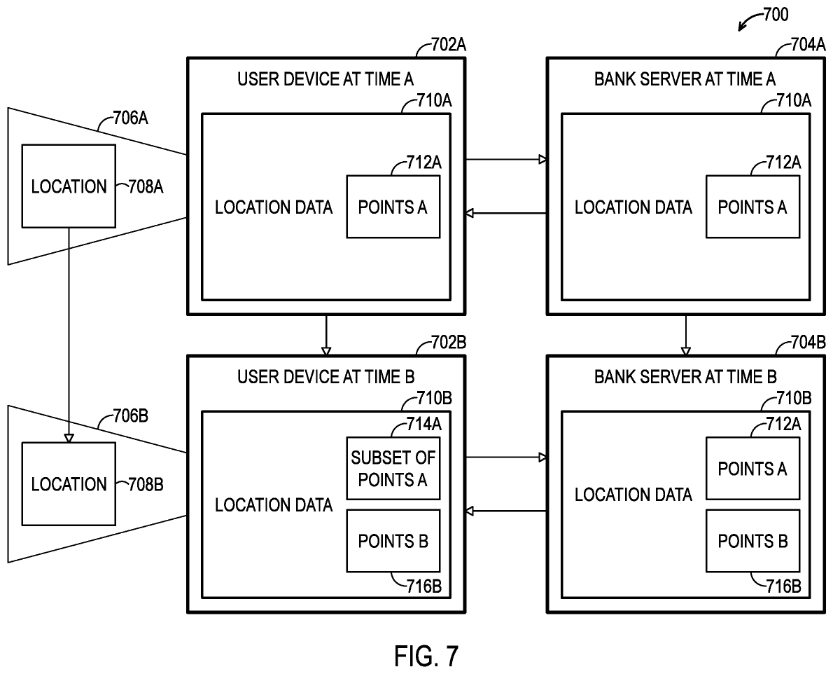

As shown in FIGS. 6 and 7, this section describes illustrative Proof-of-Location systems 600 and 700, wherein Proof of Location is used for user authentication and to verify a user's identity. In some examples, Proof-of-Location systems 600 and 700 may be utilized for two factor authentication for a user's accounts (e.g., bank account, computer system account, and/or any other suitable account).

As shown in FIG. 6, system 600 includes a first user device 604 operated by a first user 602 at different times A, B, and C. User device 604 may include any suitable mobile digital device (e.g., smart phone) configured to image a location 606. One or more trackable feature(s)/object(s) 608 are disposed at location 606. One or more software applications are stored on user device 604, and the one or more software applications include one or more algorithms configured to generate Verification-of-Location data and/or other suitable data relating to location 606. In some examples, the Verification-of-Location data generated by user device 604 includes a point cloud of trackable feature 608 disposed at location 606. In some examples, the Verification-of-Location data is generated by device 604 in response to Proof-of-Location data (e.g., received by the device from a server or other suitable device at time A and/or at a suitable earlier time).

In FIG. 6, first user 602A-C, user device 604A-C, location 606A-C, and trackable feature 608A-C each refer to the same first user 602, user device 604, location 606, and trackable feature 608 at different moments in time A, B, and C.

At first time A, first user 602A directs a field of view 610A of user device 604A toward location 606A and trackable feature 608A. The one or more software applications stored on user device 604A generate first Verification-of-Location data 612A and the first Verification-of-Location data is stored on user device 604A.

At later time B, first user 602B directs field of view 610B of user device 604B toward location 606B and trackable feature 608B. The one or more software applications stored on user device 604B generate second Verification-of-Location data 612B and the second Verification-of-Location data is stored on user device 604B. First Verification-of-Location data 612A and second Verification-of-Location data 612B are compared (e.g., by first device 604 and/or by a third party system in communication with the first device) to verify that location 606A and 606B are the same location (e.g., that the location of device 604 at time A is the same as the location of the device at time B).

In some examples, at a later time C, third Verification-of-Location data 612C is generated and compared to first Verification-of-Location data 612A and/or second Verification-of-Location data 612B to verify that location 606C is the same location as locations 606A and 606B. In other examples, no data is generated at time C. In other examples, data is generated at additional times beyond time C.

In some examples, one or more aspects of trackable feature(s) 608 at location 606 changes between the different moments in time A, B, and C. For example, shadows may change size, shape, and/or position; lights may be turned on or off; doors or windows may be opened to different degrees; the combination of cars parked in a parking lot may change; leaves may fall from trees; etc. As a result, third Verification-of-Location data 612C may fail to sufficiently match data 612A and thus may incorrectly fail to verify that the location of the device at time C is the same location as at time A. In such examples, third Verification-of-Location data 612C may further be compared to second Verification-of-Location data 612B. Because second Verification-of-Location data 612B was generated at time B, which is closer in time to time A than is time C, the one or more aspects of the trackable features that differed at times A and C may be similar enough at times B and C to verify the location at time C. That is, data 612C may sufficiently match data 612B to determine that the data 612C and 612B correspond to the same location. If data 612B also matches 612A sufficiently to determine that 612A and 612B correspond to the same location, it may be inferred that 612C and 612A also correspond to the same location. In this manner, comparing Verification-of-Location data generated at a given time to data generated at two or more previous times facilitates system 600 accounting for changes in the trackable feature(s) disposed at the location through time.

Verifying that locations 606A-C are the same location at different moments in time may be utilized to verify an identity of first user 602. For example, location 606A-C may be a portion of the first user's office, home, and/or any other suitable location that is private to the user. By verifying the user device is at the location private to the user, it may be inferred that the first user is in control and/or possession of the user device at the location. In contrast, a failed attempt to verify that the user device is at the location may indicate that the device has been lost or stolen and may be in possession of an unauthorized person. In some examples, in response to verifying the user's identity in this manner, device 604 is configured to unlock, the verification is used as part of a multi-factor authentication security measure on a bank account of the first user, and/or device 604 and/or any other suitable system uses the verification for any other suitable purpose.

As shown in FIG. 7, Proof-of-Location system 700 includes a user device 702A-B in communication with a bank server 704A-B, such that information may be communicated between user device 702A-B and bank server 704A-B. User device 702A-B has a field of view 706A-B directed toward a location 708A-B. User device 702A and 702B, bank server 704A and 704B, field of view 706A and 706B, and location 708A and 708B, each refer to the same user device, bank server, field of view, location at different moments in time (time A and time B). In this example, the server is associated with a bank, but in other examples the server may be associated with any other suitable entity.

In some examples, system 700 is utilized to verify a user's identity, such that the user is allowed access to the user's bank account and/or other suitable sensitive information. For example, at a first time A, user device 702A generates Verification-of-Location data 710A associated with location 708A. Verification-of-Location data 710A may include, e.g., one or more point clouds generated of trackable features disposed at location 708A. Verification-of-Location data 710A is communicated to bank server 704A and Verification-of-Location data 710A is saved on bank server 704A.

At a later time B, the user of user device 702B wants to access their bank account and/or perform a specific action on their bank account (e.g., transfer money). Accordingly, the user directs field of view 706B of device 702B toward the same location 708B and user device 702B generates second Verification-of-Location data 710B at time B. Second Verification-of-Location data 710B is communicated to bank server 704B. Bank server 704B then compares second Verification-of-Location data 710B to first Verification-of-Location data 710A to verify that the location of user device 702B is the same as the location of user device 702A (that is, that the device was in the same place at times A and B). Bank server 704B may then grant the user access to the account and/or accept the user's request to transfer money, or take another suitable action.

In some examples, when the user wants to access their bank account at time B, they cause user device 702B to download Verification-of-Location data 710A (or a subset of data 710A, and/or data based on data 710A) from the server and generate Verification-of-Location data 710B based on data 710A. For example, in some cases, Verification-of-Location data 710A includes a set of data points of a point cloud 712A corresponding to a trackable feature at location 708A. At time B, user device 702B downloads a randomized subset 714A of the data points of point cloud 712A and user device 702B relocalizes to randomized subset 714A of point cloud 712A. In the process of relocalizing to randomized subset 714A, user device 702B generates additional data points 716B corresponding to other data points of point cloud 712A that are not included in randomized subset 714A. Additional data points 716B are sent to bank server 704B and compared to the data points of point cloud 712A that were not included in randomized subset 714A. If points 716B sufficiently correspond to the points of cloud 712A omitted from subset 714A, the bank server verifies the location of user device 702B at time B.

### D. Illustrative Proof-of-Location System Utilizing Masking

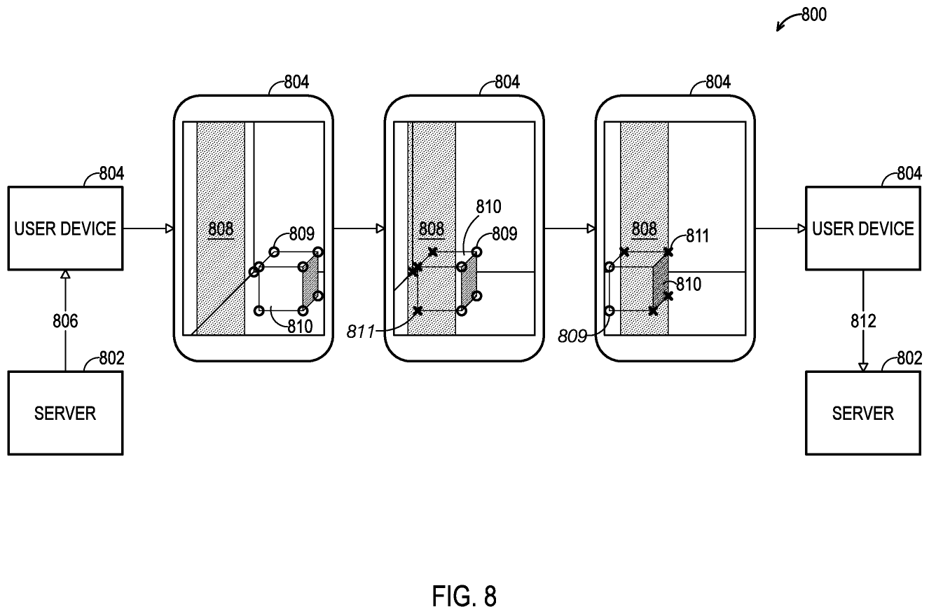

As shown in FIGS. 8-10, this section describes an illustrative Proof-of-Location system 800, wherein masking is utilized to change how a point cloud is generated for Verification-of-Location data and compared to reference data in accordance with aspects of the present disclosure.

As shown in FIG. 8, a server 802 is connected to a user device 804, such that Proof-of-Location data 806 is communicated by server 802 to user device 804. Proof-of-Location data 806 includes a location to generate a point cloud at, a mask 808 to apply to images or video captured by user device 804, and instructions for the user to move the device in a particular manner while capturing image or video. Mask 808 is configured to cover a portion of the images or video captured by user device 804. As described below, mask 808 may be hardware mask and/or a software mask.

As shown in FIG. 8, user device 804 is utilized to generate a video (and/or other series of images) of a location having a trackable feature 810. Mask 808 is applied to the video captured by user device 804, such that a portion of the captured video feed that would have been present without the mask is removed. In this example, the blocked portion of the video feed comprises a strip extending from top to bottom of the field of view, between the center and left edge of the field of view (as viewed by a user looking at a display of the device as the device captures the video).

User device 804 includes a software application having one or more feature extraction algorithms configured to generate Verification-of-Location data. In this example, generating the Verification-of-Location data includes generating a point cloud of trackable feature 810 in the video. The user moves device 804 according to the instructions of Proof-of-Location data 806 to scan over feature 810. In the depicted example, the user moves the device horizontally from left to right. As the user scans over trackable feature 810 with user device 804, different portions of the trackable feature are covered by mask 808, such that only certain subsets of data points of the point cloud of the trackable feature can be generated at certain points in time. The Verification-of-Location data generated by the feature extraction algorithms includes the different subsets of points generated at each point in time.

After the user has scanned user device 804 in the instructed manner and generated the Verification-of-Location data, user device 804 communicates Verification-of-Location data 812 to server 802. Server 802 compares the generated Verification-of-Location data 812 to an expected set of data corresponding to the verification data expected to be generated by a device present at the location that was moved in the manner instructed (e.g., an estimate of the subsets of data points of the point cloud of the trackable feature, or a previously generated series of subsets generated by a user at the location who applied the mask and moved their device in the instructed manner). Accordingly, comparing the Verification-of-Location data to the expected data includes accounting for mask 808. Utilizing a mask when generating Verification-of-Location data facilitates reducing the possibility of a user of user device 804 spoofing the Verification-of-Location data.

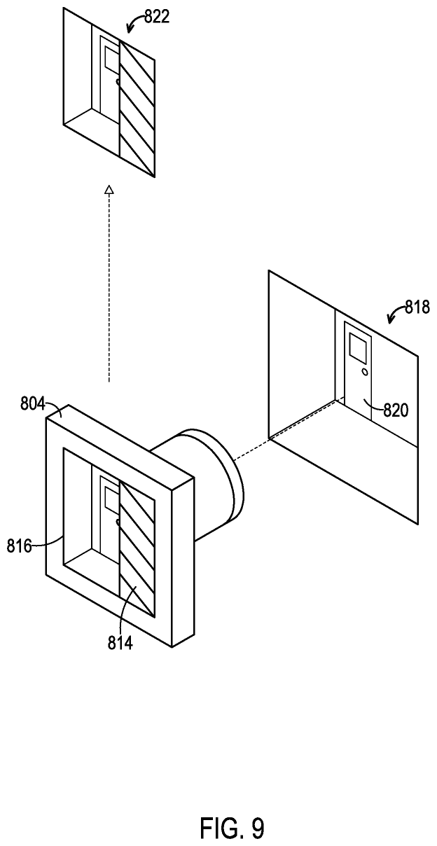

In some examples, as depicted in FIG. 9, a hardware mask 814 is utilized in the Proof of Location process. Hardware mask 814 is an example of mask 808, but is not limited to use in the example described above including mask 808. Hardware mask 814 may comprise any suitable component configured to physically block a portion of a CMOS 816 (or other suitable image sensor) of user device 804 from receiving light from an environment 818. Hardware mask 814 may have any suitable shape and/or size configured to block the portion of CMOS 816 from receiving the light. As shown in FIG. 9, a portion of the field of view of the user device is blocked by hardware mask 814.

In some examples, the Proof-of-Location data communicated by server 802 to user device 804 includes instructions indicating a specific hardware mask 814 for the user to apply to CMOS 816 of user device 804. For example, the user's device may include one or more available hardware masks that can be applied to the image sensor, or the user may have one or more hardware masks that can be attached to the device for use in the Proof-of-Location system. The user applies the specified hardware mask 814 to CMOS 816 and captures image(s) and/or a video of a trackable feature 820 in environment 818. User device 804 includes a software application having one or more feature extraction algorithms configured to, based on images or video of environment 818, generate Verification-of-Location data 822 associated with trackable feature 820 in environment 818. Verification-of-Location data 822 may comprise a generated point cloud of trackable feature 820, data related to relocalization of user device 804 to a previously generated point cloud of trackable feature 820, and/or any other suitable data. The Verification-of-Location data 822 generated by user device 804 is sent from user device 804 to a server and/or third party for verification. The server or third party compares the generated Verification-of-Location data 822 to expected data expected to be generated by a device applying mask 814 to determine whether to establish Proof of Location for user device 804.

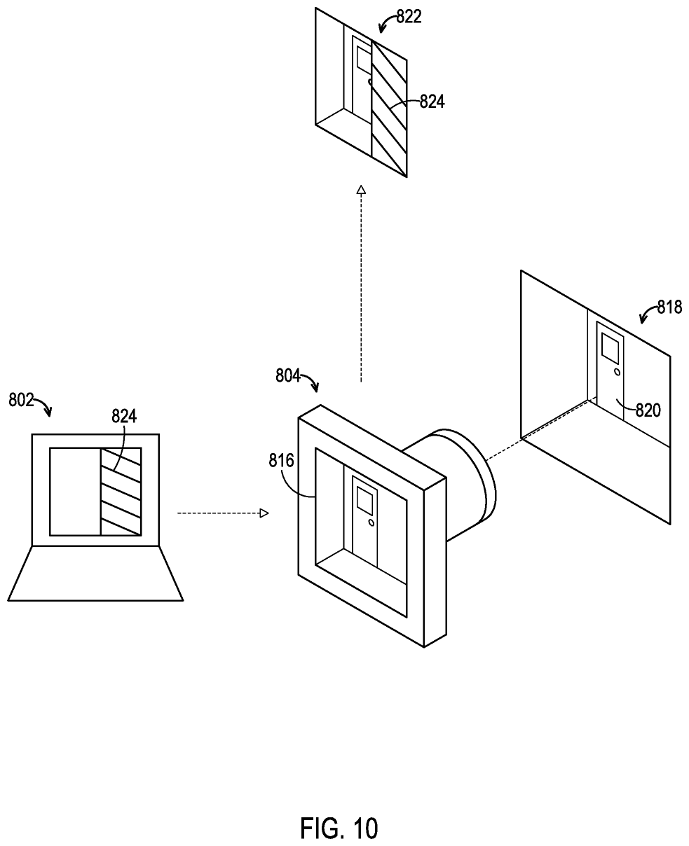

In some examples, as depicted in FIG. 10, a software mask 824 is utilized in the Proof of Location process. In such examples, the Proof-of-Location data communicated by the server and/or third party to user device 804 may include a specific software mask 824 to be utilized when capturing the images and/or video of trackable feature 818 in environment 820 (e.g., the data may include instructions identifying a mask to be applied and/or may comprise data sufficient to enable to the user device to create and apply the mask). Software mask 824 comprises data indicating to a processor of user device 804 to process only specific portions of the images and/or video captured by CMOS 816. When software mask 824 is utilized, CMOS 816 of user device 804 is not physically blocked and CMOS 816 receives the entirety of the image and/or video of environment 820 within the field of view of the device. The one or more software applications of user device 804 generate Verification-of-Location data 822 based on the images and/or videos having software mask 824 applied by the processor. Verification-of-Location data 822 is communicated to a server and/or a third party to be compared to expected data (e.g., data based on and/or including Proof-of-Location data 806) to generate Proof of Location for user device 804. In the example of FIG. 10, software mask 824 comprises a strip extending from the top to the bottom and disposed on a right side of the captured image or video. However, software mask 824 may have any suitable shape and/or size, and the shape and/or size of the mask may be configured to change (e.g., over time and/or based on suitable factor(s)).

Utilizing hardware mask 816 and/or software mask 824 reduces the probability of spoofing the Verification-of-Location data. It would be difficult for a malicious user to recreate the images or video that a user device at the location would generate with the specified mask applied. The specific hardware mask 816 and/or software mask 824 for the user to utilize while generating the Verification-of-Location data may be communicated to the user from the server at the time the user requests to generate Proof-of-Location. In some examples, the user may be required to generate the Verification-of-Location data with the mask applied in a set amount of time after the mask is sent to the user's device, or else the request for Proof of Location will fail even if Verification-of-Location data matches the expected data. This ensures that the user does not have enough time to utilize brute force methods to recreate the video or images with the specific mask applied. In some examples, the user is instructed to utilize both a hardware mask and a software mask.

In some examples, the expected data to which the Verification-of-Location data is compared (e.g., predicted or previously sensed data expected to be generated by a device applying the mask while imaging the location) accounts for specific aspects of the device hardware, such as a lens and/or gyroscope. In some cases, images acquired by a particular device are highly sensitive to such aspects of the hardware, such that an image acquired by the device bears characteristics of the lens, gyroscope, and/or other component of the device. Accordingly, the expected data may correspond to image data expected to be acquired by a particular type of device (e.g., a particular model of smartphone or camera). This can help make the data hard to spoof, because a malicious actor attempting to spoof the data would need to account for specific aspects of the device hardware in generating the fake data.

### E. Illustrative Proof-of-Location System Utilizing User Movement

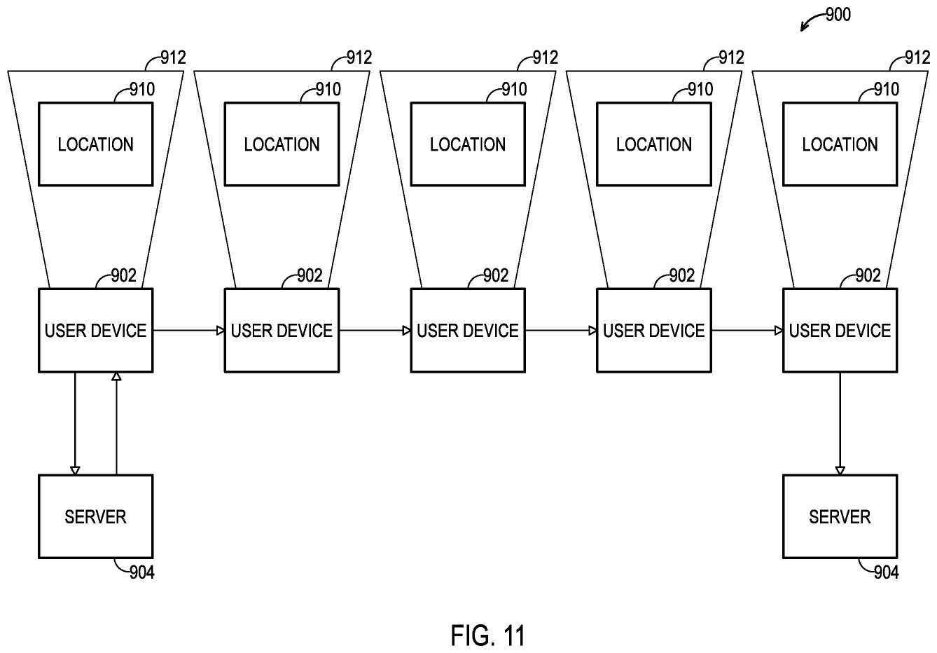

As shown in FIG. 11, this section describes an illustrative Proof-of-Location system 900, wherein a user receives specific instructions from a server for how they should move their device while generating their Verification-of-Location data, in accordance with aspects of the present disclosure.

As shown in FIG. 11, Proof-of-Location system 900 includes a user device 902 in communication with a server 904, such that information may be communicated by user device 902 to server 904, and information may be communicated by server 904 to user device 902. Information communicated by server 904 to user device 902 may include Proof-of-Location data relating to a location 910, including instructions configured to direct a user of user device 902 to collect Verification-of-Location data relating to location 910 by moving the device in a specific manner. User device 902 includes a software application configured to utilize images or video of location 910 to generate the Verification-of-Location data (e.g., by generating a point cloud, localizing to a point cloud, and/or in any other suitable manner).

A user of user device 902 directs a field of view 912 of user device 902 at location 910, such that user device 902 captures a video of location 910. As user device 902 is capturing the video of location 910, the user of the user device moves the device relative to location 910 according to instructions received from the server (and/or from another suitable source). The instructions may be communicated to the user along with the rest of the Proof-of-Location data, in real time as the user captures video data, and/or at any other suitable time.

One or more sensors of user device 902 senses data reflecting the motion pattern of the device. For example, moving user device 902 causes the video captured by the user device to comprise different views (e.g., different perspectives from different positions and/or orientations) of location 910 and trackable features disposed at location 910. Additionally, or alternatively, the device may include an IMU and/or other suitable motion sensor configured to sense data reflecting the motion of the device. In general, any suitable combination of sensor(s) may be used to acquire data corresponding to the motion of the device. The sensed data corresponding to the motion may be used instead of, or along with, other types of Verification-of-Location data described herein. For example, in addition to (or instead of) the sensed motion data, the device may also generate a point cloud of a trackable feature, relocalize to a trackable feature, and/or generate other Verification-of-Location data. Verification-of-Location data reflecting the motion of the device may be more difficult to spoof than data acquired from a single vantage point; for example, it may be difficult for a malicious actor to create false image data that replicates the Verification-of-Location data, and it is unlikely that the malicious actor happens to have prerecorded data reflecting the particular motion pattern of the device used to generate the true Verification-of-Location data.

The user device communicates Verification-of-Location data 914 to server 904. Server 904 includes one or more algorithms configured to generate Proof of Location for the user device based on a comparison of the Verification-of-Location data and reference data (e.g., an estimate of what the Verification-of-Location data would be if actually generated by a device present at the location). The server verifies Proof of Location for the device if the Verification-of-Location data corresponds to the reference data to a suitable degree.

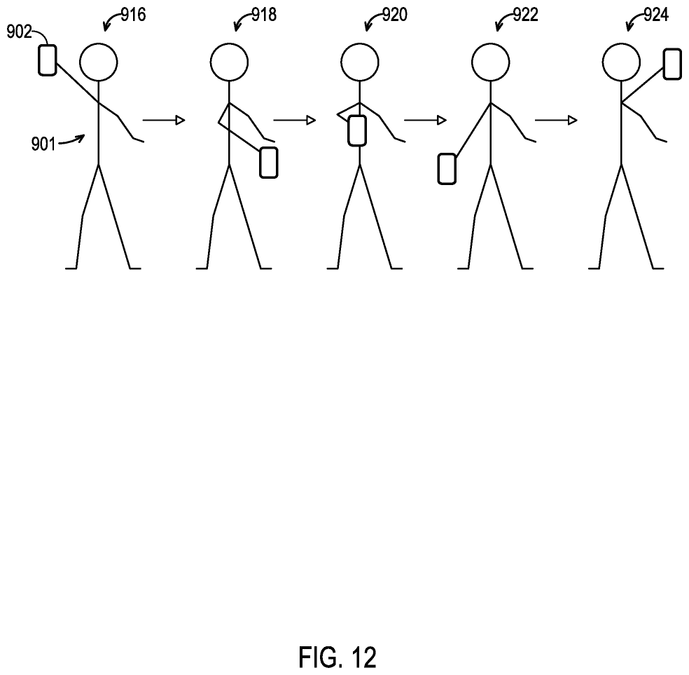

FIG. 12 depicts an example series of motions a user 901 of user device 902 is instructed to perform while capturing the series of images and/or video of location 910. In this example, user 901 is instructed to move user device 902 upwards and to the right 916, downwards and to the left 918, to a neutral position 920, downwards and to the right 922, and upwards and to the left 924. However, user 901 may be instructed to perform any suitable series of motions. While user 901 moves user device 902 as instructed, user device 902 captures the images and/or video of the location from the different perspectives and/or IMU data embodying the motion of the device. The software application on user device 902 utilizes the video data and/or IMU data to generate Verification-of-Location data. The Verification-of-Location data is utilized by user device 902 and/or a server to establish Proof of Location for user device 902.

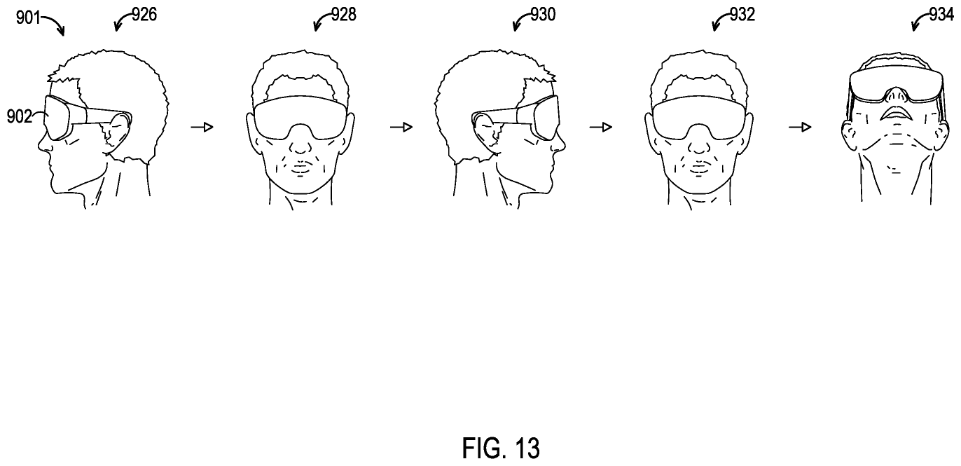

FIG. 13 depicts an example series of motions a user 901 may be instructed to perform when user device 902 comprises a head-mounted display (HMD). In such examples, the instructions may include a series of head motions (e.g., to the right 926, neutral 928, to the left 930, neutral 932, upwards 934, etc.) for user 901 to perform. As user 901 performs the series of head motions, head-mounted display 902 captures a video of environment 910 having the trackable feature. The video is, or is utilized to generate, the Verification-of-Location data. The Verification-of-Location data is utilized by head-mounted display 902 and/or sent to a server to establish Proof of Location for head-mounted display 902.

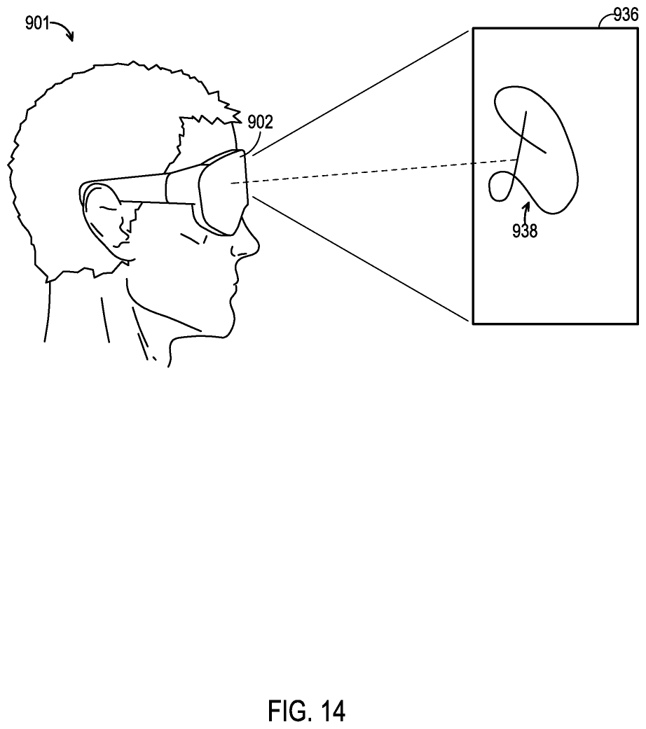

Alternatively or additionally to a series of head motions, user 901 may be instructed to perform a series of eye motions 938 over a trackable background 936 (e.g., with a trackable feature of the location as the background to where the user is looking) while wearing head-mounted display 902, as shown in FIG. 14. In such examples, user 901 may be asked to follow a dot displayed on the head-mounted display with the user's eyes, to trace their gaze along a feature in the field of view of the device (e.g., “move your gaze along the profile of this building”), to move their eyes in a specified pattern (e.g., “trace an imaginary letter D with your gaze”), and/or otherwise informed of a manner in which they are to move their gaze. Head-mounted display 902 generates optical data from the perspective of the gaze of the user over the trackable feature at the location. For example, head-mounted display 902 may sense data indicating the direction and depth of focus of the user's eyes as the user follows the dot displayed with the user's eyes. The sensed data is sent to the server for analysis. The server establishes Proof of Location if the user's eye motions are within an acceptable range, or in some examples, if the user's eye motions are within an acceptable range and image data captured from the user's perspective indicates that the user is, in fact, within view of the trackable feature at the location.

In some examples, the user is instructed to generate the Verification-of-Location data while moving the device or while moving their gaze as a second step in a 2-step location verification sequence. In such examples, the first step in the location verification sequence may include the user generating initial Verification-of-Location data without moving user device 902 (e.g., by generating a point cloud or relocalizing to a point cloud while user device is approximately stationary). The second step may include generating the Verification-of-Location data while performing the device and/or eye movements as described above with reference to FIGS. 11-14. Utilizing a 2-step location verification sequence increases the confidence in the Proof-of-Location generated for the user.

### F. Illustrative System for Verifying Proof-of-Location Data

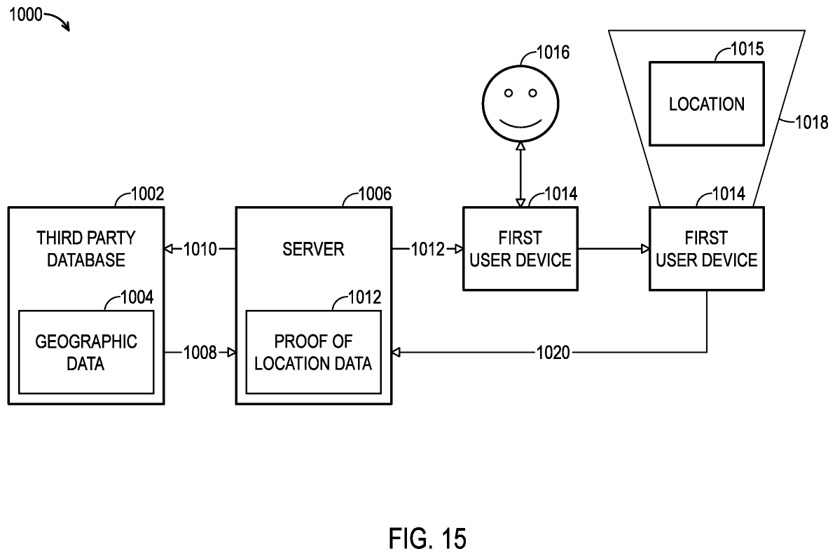

As shown in FIG. 15, this section describes an illustrative Proof-of-Location system 1000, wherein Proof-of-Location data about a location is based on data stored at a third-party database.

There are many possible third-party databases that store information suitable to be used as and/or used to generate Proof-of-Location data to establish Proof of Location for a user. Some such example databases include Google Earth and Google Street View.

As shown in FIG. 15, system 1000 includes a third-party database 1002 storing geographic data 1004. Geographic data 1004 may include GPS coordinates, addresses, live video or images of the environment at the GPS coordinates or addresses, and/or any other suitable information relevant for identifying a location. Third-party database 1002 is in communication with a server 1006, such that information 1008 can be communicated by third-party database 1002 to server 1006, and information 1010 can be communicated by server 1006 to third-party database 1002. Information 1008 communicated by the third-party database 1002 to the server 1006 may include geographic data 1004.

In some examples, server 1006 and/or one or more data processing systems in communication with the server include one or more computer vision algorithms (e.g., feature descriptor extraction algorithms) configured to generate Proof-of-Location data 1012 associated with trackable features depicted in the images or video of the geographic data at third-party database 1002. For example, the server may generate a point cloud(s) of a trackable feature depicted in an image stored at the third-party database. The generated point cloud, together with information specifying the location of the feature (e.g., a set of GPS or other WGS coordinates), is Proof-of-Location data 1012.

In some examples, generated Proof-of-Location data 1012 is tested by a user (e.g., before being put into use to establish Proof of Location). To test the Proof-of-Location data 1012 generated using the geographic data from the third-party database for a specific location 1015, a first user 1016 may receive the Proof-of-Location data 1012 at a first user device 1014. First user 1016 travels to (or is already at) the GPS coordinates included in the Proof-of-Location data and utilizes first user device 1014 to scan location 1015. For example, first user 1016 may direct a field of view 1018 of user device 1014 toward location 1015 to capture a series of images or video of location 1015. A software application of first user device 1014 generates Verification-of-Location data 1020 associated with location 1015 (e.g., a point cloud to be compared to the point cloud generated based on the stored third-party data). The generated Verification-of-Location data 1020 is communicated back to the server 1006. If server 1006 is able to generate Proof of Location for first user 1016 based on the Verification-of-Location data, it may be inferred that Proof-of-Location data 1012 generated based on the third-party data is suitable for use for establishing Proof of Location. Accordingly, the Proof-of-Location data generated based on the geographic data of the third-party database may be approved to be used as Proof-of-Location data in other instances.

If server 1006 is unable to generate Proof of Location based for the first user based on the Verification-of-Location data, it may be inferred that Proof-of-Location data 1012 is not currently suitable for use for establishing Proof of Location. Any suitable action may be taken in response. For example, server 1006 may send a message to first user device 1014 requesting the first user to provide information related to the failure to generate Proof of Location. This may, e.g., allow the first user to provide input saying that the trackable feature of location 1015 has changed relative to the image information of geographic data 1004 (e.g., the stored third-party information is out of date), that the GPS coordinates of data 1004 were inaccurate and the stored image does not correspond to location 1015, that the image appears to correspond to the location but the image is too low quality to yield suitable Proof-of-Location data, and/or any other suitable response.

### G. Illustrative System for Location Verified Images

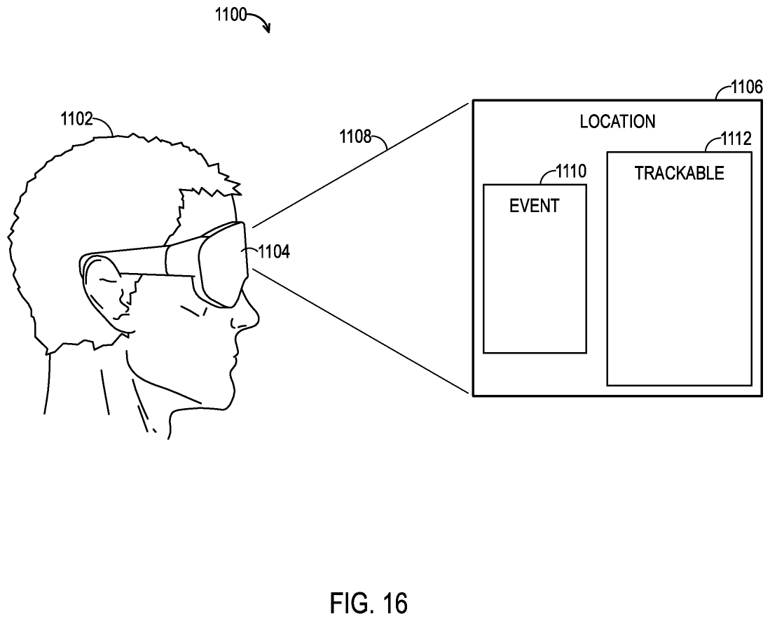

As shown in FIG. 16, this section describes an illustrative Proof-of-Location system 1100 for generating location verified images or video of themselves, an event, and/or person of interest.

AI is capable of making false image and deepfakes that diminish the public trust in images and videos posted online. Proof-of-Location system 1100 and other Proof-of-Location protocols described herein can be utilized to provide verification that images or videos of an event are taken at a specific location rather than having been created artificially.

System 1100 includes a user device 1104 used by user 1102. As shown in FIG. 16, user device 1104 comprises a head-mounted display, however, user device 1104 may comprise any suitable mobile digital device (e.g., smart phone) configured to be utilized by user 1102 to image a location 1106. The imaging device of mobile device 1104 includes a field of view 1108 encompassing at least a portion of location 1106.

In some examples, user device 1104 is configured to establish an identity of user 1102. For example, a head-mounted display may scan the retina(s) of user 1102 wearing the display to determine the identity of user 1102. This may be useful to prove that a specific individual captured the images or video taken with user device 1104.

In some examples, user 1102 witnesses an event 1110 take place at location 1106. For example, event 1110 may include a speech, a celebrity sighting, a person signing an important document, and/or any other suitable event. User 1102 directs field of view 1108 of the imaging device of mobile device 1104 towards location 1106 to capture one or more images and/or a video of event 1110. One or more trusted trackable features 1112 (e.g., a portion of a nearby building) are disposed at location 1106 within field of view 1108 of mobile device 1104. User device 1104 includes one or more AR-enabled applications configured to generate Verification-of-Location data associated with trackable feature 1112. For example, Verification-of-Location data may comprise data relating to relocalizing the device to a previously generated point cloud of trusted trackable 1112 and/or may comprise a point cloud of trusted trackable feature 1112 generated by user device 1104. User device 1104 generates the Verification-of-Location data associated with trackable feature 1112 while capturing the images or video of event 1110. The generated Verification-of-Location data is then utilized by user device 1102 and/or sent to a server to establish Proof of Location for user device 1102 at location 1106 when the images and/or video were captured.

In some examples, a server or other system is configured to provide user 1102 a spatial authenticity certificate (AKA a Proof-of-Location Reality Certificate) based on the images and/or video captured of event 1110. For example, user device 1104 communicates the Verification-of-Location data (e.g., data associated with relocalizing to trusted trackable 1112) to a server. The server verifies that the Verification-of-Location data is sufficient to prove that user device 1104 was in view of trackable 1112 while the images or video of event 1110 were captured. The server communicates the spatial authenticity certificate to user device 1104. The certificate may be embedded into the image or video of event 1110 (e.g., as a watermark in the image data, as information embedded in the image metadata, and/or in any other suitable manner). For example, the certificate may be embedded in the image or video utilizing image provenance technology (e.g., Truepic). The certificate would improve trust for other individuals viewing the image that the image or video was, in fact, captured at location 1106.

The spatial authentication certificate comprises data unique to the specific trackable feature 1112 and is different from the spatial authentication certificates of other trackable features. The trust that a system or individual places in each unique spatial authentication certificate may be dependent on how often and how recently the specific trackable feature 1112 is utilized to generate Proof of Location for individuals. Spatial authentication certificates associated with Trackable features that are frequently utilized to generate Proof of Location may be deemed to establish a high level of trust that images embedded in which that certificate is embedded were, in fact, taken at the location of the trackable feature. Trackable features that have recently been established and/or that are not frequently used to generate Proof of Location may not have a spatial authentication certificate and/or may have a spatial authentication certificate with a relatively low level of trust.

The unique spatial authentication certificate for any given specific trackable may be publicly available or privately owned. If the unique spatial authentication certificate of the trackable feature is publicly available, any individual may generate an image with the trackable in view and receive the unique spatial authentication certificate for the trackable feature embedded in the image. Alternatively, the unique spatial authentication certificate of certain trackables may be privately owned (e.g., by a business or a celebrity). In such examples, the owner of the certificate may sell the spatial authentication certificate to individuals that wish to capture a location verified image or video with the embedded spatial authentication certificate. An image taken without authorization to use the certificate would not have the certificate embedded therein.

In some examples, each of the images or videos having the embedded spatial authentication certificate is configured to only be alterable by editing software configured to create a record of any derived versions of the image or video (e.g., such that there is a record of all changes ever made to the image in which the certificate is embedded). In some examples, the derived versions of the certified images or video are recorded via blockchain. Copies of the images or video that are made without the embedded spatial authentication certificate would then be known to be forgeries of the original image or video.

In some examples, certain trackable features in popular public areas may be utilized as public “areas of verification” at which individuals can have an event validated by a plurality of strangers. For example, an individual signs a document in front of a trackable feature in a public space that many strangers are imaging at the same time for their own personal reasons. The images and/or video taken by the strangers provide evidence that the individual signed the document at that location at that specific time.

System 1100 has various different use cases. For example, a celebrity may set up an event for followers of the celebrity at which the followers can take verified images with the celebrity. In such examples, the celebrity establishes trackable feature 1112 at location 1106 and/or uses a previously established trackable feature at location 1106. The celebrity makes a post on a social media platform (e.g., Instagram) featuring themselves and trackable feature 1112. In some examples, the post is embedded with the unique spatial authentication certificate for trackable feature 1112. Followers of the celebrity receive a notification indicating the celebrity's location and go to the location to meet the celebrity. The followers use respective mobile digital devices 1104 to capture images or video with the celebrity in front of or in view of trackable feature 1112. Mobile digital device 1104 generates Verification-of-Location data that is utilized by the mobile digital device and/or sent to a server to generate Proof of Location for the follower and the image. As described above, the followers could then receive the unique spatial authentication certificate associated with trackable feature 1112 embedded in the image. The spatial authentication certificate provides verification that the image or video was taken at the same location as the celebrity's post.

As more and more followers utilize trackable feature 1112 established by the celebrity to generate the certified images with the celebrity, trust in trackable feature 1112 and the associated spatial authentication certificate would increase. The many different certified images with the celebrity would effectively verify that the celebrity visited location 1106 and was in view of trackable 1112. Even after the celebrity left location 1106, other individuals could arrive and capture images or video with trackable feature 1112 that is associated with the celebrity. In some examples, celebrities may sell appearances such as this to businesses that hope foot traffic will increase based on people coming to see the celebrity or later to visit a place the celebrity is known to have been.

In another example, user 1102 wishes to capture location-verified images of event 1110 at location 1106, but there are no trusted trackable features at location 1106. In such examples, user 1102 can establish a new trackable feature 1112 at location 1106 by utilizing user device 1104 to generate a point cloud of the trackable feature. User 1102 captures one or more images or video of event 1110 (e.g., signing of a document) while new trackable feature 1112 is within field of view 1108 of the device. Newly established trackable feature 1112 would initially have no public trust because no other individuals have utilized the feature to establish Proof of Location. Thus, initially the images or video captured by user device 1104 of event 1110 with trackable feature 1112 would not provide sufficient evidence that event 1110 occurred at location 1106. In order to increase trust in newly established trackable feature 1112, user 1102 could stake a reward (e.g., digital currency, in-game items, etc.) given to other individuals that utilize newly established trackable feature 1112 to establish Proof of Location. Eventually, after enough individuals establish Proof of Location utilizing trackable feature 1112, trackable feature 1112 would become trusted and the images or video previously captured by user 1102 of event 1110 at location 1106 are verified.

In some examples, system 1100 is utilized to generate a location-verified video in which trackable feature 1112 is not within field of view 1108 of user device 1104 for the entirety of the video. In such examples, the video may start with trackable feature 1112 within field of view 1108 of user device 1104 and end with trackable feature 1112 within the field of view of the user device, but include intermediate portions in which the trackable feature is outside the field of view. Proof of Location can be established for the video when trackable feature 1112 is within the field of view of the user device. For the portions of the video when trackable feature 1112 is not within the field of view of user device 1102, inertial measurement unit (IMU) data recorded by user device 1102 is utilized to track the path of user device 1102 relative to trackable feature 1112. The IMU data combined with the established Proof of Location is utilized to determine the path the device traveled relative to trackable feature 1112 when capturing the video. If the determined path is consistent with a video acquired by an image sensing device present at the location, Proof of Location may be established.

Another use case of system 1100 is to verify the signing of a document at a specific location. In this example, event 1110 comprises the signing of the document at location 1106. User 1102 directs field of view of 1108 of user device 1104 at location 1106 and a trusted trackable feature 1112 is within field of view 1108 at location 1106. User 102 utilizes user device 1104 to capture one or more images and/or a video of themselves or another party signing the document while trackable feature 1112 is within view of the device. User device 1104 generates Verification-of-Location data usable by the device and/or a server to establish Proof of Location for the device at location 1106. In some examples, the images or video of the document being signed are embedded with the spatial authentication certificate associated with the trackable to certify that the images or video show the document being signed at location 1106. In some examples, user device 1104 determines the identity of user 1102 that captured the images or video of the document being signed using user device 1104. For example, a head-mounted display scans the retinas of user 1102 to determine the identity of user 1102. The images or video then are embedded with additional information indicating the identity of user 1102. This information may, e.g., be usable to establish user 1102 as a witness of the signing of the document (or other event).

In some examples, system 1100 is utilized to verify that images for insurance claims (e.g., auto, real estate, etc.) are not faked or modified. For example, pre-incident and post-incident photos may be captured with the same trackable feature within view, such that the photos are verified to have been taken at the same location. The pre-incident and post-incident photos could then be trusted to depict the specific damages caused by the incident. An owner of the vehicle, home, or other object being insured could periodically capture pre-incident photos to be used in case an incident occurs.

In some examples, system 1100 is utilized to maintain supply chains and/or to verify the origin of products. It can be important to know the origins of a product to ensure that the product has been ethically sourced, free of allergens or contaminants, prepared according to religious protocols, and/or otherwise in a desired condition. Proof of Location for a batch of a product (e.g., food, medicine, clothing, etc.) can be established at specific checkpoints in a supply chain by capturing location verified images or video of the product at the checkpoint in view of a trusted trackable feature. In some examples, the video or images can show an individual testing the batch to validate the quality of the product. In some examples, the video or images can show the individual packaging and sending a sample of the batch to a third party for verification. The location verified images of the product can be utilized to create trust in the origin of the product. Additionally, the location verified images can be utilized to ensure that the product went through the intended checkpoints along the supply chain and the supply chain is functioning as intended.

In some examples, system 1100 is utilized to prove that an important shipment arrived at the intended destination without being stolen. For example, system 1100 can be utilized to prove that food and medicine shipments for refugees or natural disaster areas arrive at the correct location. Individuals at the intended destination can image the shipments of the food or medicine in view of a trusted trackable to generate a location verified image proving that the shipment arrived at the correct location.

H. Illustrative Method for Generating Proof of Location without a Trusted Trackable

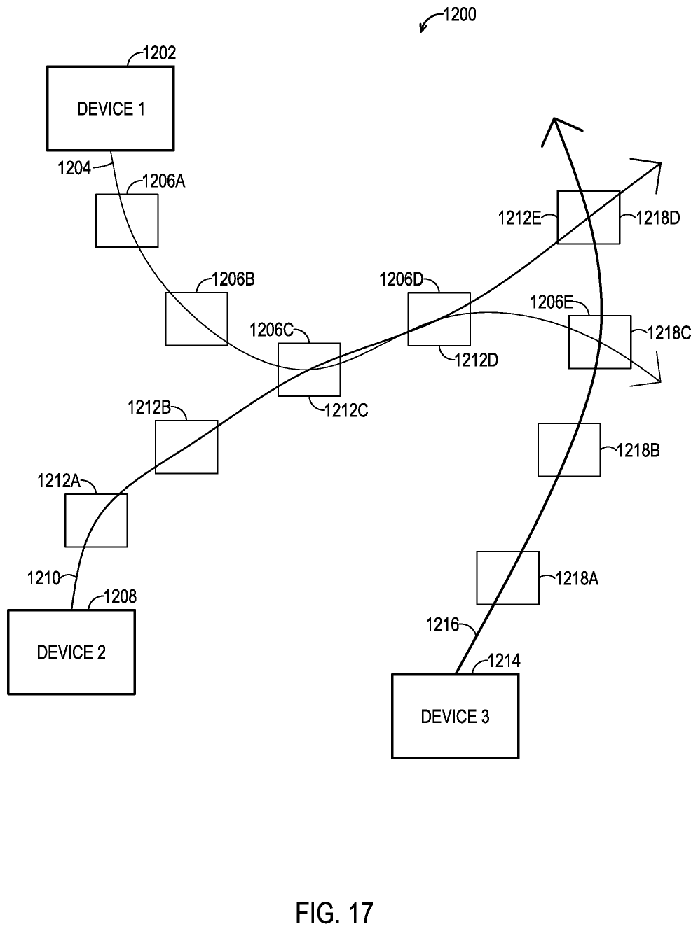

As shown in FIG. 17, this section describes an illustrative Proof-of-Location system 1200 configured to facilitate individuals establishing Proof of Location for themselves when no trusted trackable features are present.

In some examples, multiple individuals may need to generate Proof of Location for themselves when there are no nearby trackable features that are trusted to be utilized to generate Proof of Location at the location. In such examples, it may still be possible for multiple individuals to generate Proof of Location for themselves by localizing their respective devices to a plurality of different trackable features from different angles or perspectives.

For example, as shown in FIG. 17, a first user having a first user device 1202 travels along a first path 1204. As the first user travels along first path 1204, the first user utilizes first user device 1202 to image a series of trackable features 1206A-E along the path. One or more AR enabled applications on first user device 1202 generate Verification-of-Location data associated with each of trackable features 1206A-E along path 1204. For example, the Verification-of-Location data may comprise point clouds generated of the trackable features and/or data related to a relocalization of the device to a previously generated point cloud of the trackable features.

A second user having a second user device 1208 travels along a second path 1210. A second series of trackable features 1212A-E is disposed along second path 1210. The second user device 1208 includes one or more AR enabled applications that generate second Verification-of-Location data associated with each of trackable features 1212A-E disposed along second path 1210. In some examples, a third user having a third user device 1214 travels along a third path 1216 and generates third Verification-of-Location data associated with a third series of trackable features 1218A-D disposed along third path 1216.

As shown in FIG. 17, first path 1204 of first user device 1202 converges with second path 1210 of second user device 1208 at or near certain trackable features, such that first user device 1202 and second user device 1208 both generate Verification-of-Location data associated with the same trackable feature. In the depicted example, trackable features 1206C and 1212C are the same trackable feature and both first user device 1202 and second user device 1208 generate Verification-of-Location data associated with the feature. Similarly, as shown in FIG. 17, third path 1216 of third user device 1214 converges with the paths of first user device 1202 and second user device 1208.

First user device 1202 and second user device 1208 approach the same trackable features from different angles, such that first user device 1202 has a different perspective of the trackable feature than second user device 1208. Having multiple devices generate Verification-of-Location data of the same trackable feature from different perspectives prevents a would-be spoofer from utilizing a single video to spoof the Verification-of-Location data. This increases confidence in the Verification-of-Location data generated by the user devices even though no (or insufficient) trust in these trackable features had previously been established.

In some examples, certain time restrictions are implemented to prevent spoofing of the Verification-of-Location data generated by the first, second, and third user devices. For example, the first, second, and third user devices are required to travel along the respective paths and generate the Verification-of-Location data within a certain period of time, which is short enough that it would be difficult or impossible for a single user to traverse each path themselves with the same device within that time period. This helps to prevent a single user from posing as multiple users and falsely establishing trust in the trackables.

In some examples, after the first, second, and third user devices traverse the respective paths and each generate the Verification-of-Location associated with the trackable features along the respective paths, the data is sent to a server and/or utilized by the user device(s) themselves to establish Proof of Location. Having multiple devices each track to a series of trackable features increases the confidence in the established Proof of Location, even if individually the trackable features would not have been trusted to generate Proof of Location by themselves.

### I. Illustrative Method for Preventing Spoofing

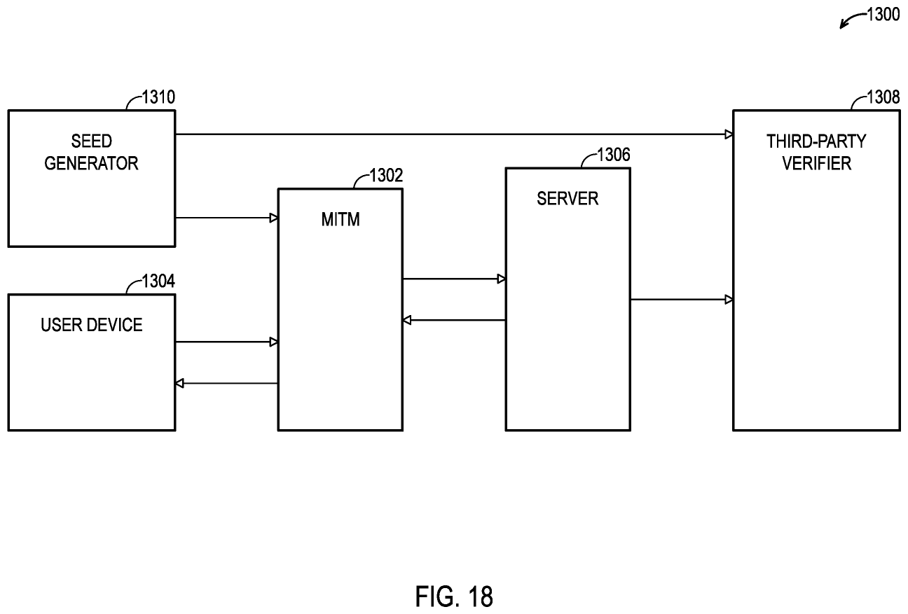

With reference to FIG. 18, this section describes an illustrative anti-spoofing system 1300 configured to defeat “Man-in-the-middle” attacks on Proof-of-Location systems, described herein. Although system 1300 is described here in context of a Proof-of-Location system, in general system 1300 (or aspects thereof) may be used to defeat “Man-in-the-middle” attacks on any system in which a user submits information (e.g., login credentials and/or other suitable information) for verification by a server or similar device.

A common technique for spoofing a 2-step verification sequence is a “Man-in-the-middle” attack. A “Man-in-the-middle” attack involves an attacker that intercepts information communicated between two parties. In the context of the Proof-of-Location systems described herein, a “Man-in-the-middle” attacker 1302 is a person who is (in general) not present at the location and who intercepts information communicated between a user device 1304 and a server 1306. For example, “man-in-the-middle” attacker 1302 intercepts Verification-of-Location data sent by user device 1304 to server 1306, such as a generated point cloud of a trackable feature at the location of user device 1304. In some examples, the Verification-of-Location data is one of two or more factors being used by the user to attempt to establish Proof of Location.

“Man-in-the-middle” attacker 1302 then communicates the Verification-of-Location data to server 1306. Server 1306, unaware that the Verification-of-Location data has been communicated by a “Man-in-the-middle” rather than the user present at the location, establishes Proof-of-Location based on the data. This may allow the attacker to fool another party into believing the attacker was verifiably at the location when they were not, and may, e.g., facilitate the attacker gaining access to another person's bank account or other valuable information. The attacker may retransmit the Proof-of-Location to the original user as though it had come directly from the server, so that the user fails to realize that anything unusual occurred.

System 1300 is configured to defeat man-in-the-middle attacks. System 1300 includes a verifier 1308, which comprises a system or device other than server 1306. Verifier 1308 may be thought of as a third-party verifier in the sense that it is configured to verify the random seed used by the server against the seed generated by the original seed generator; however, the verifier in some cases is a system operated by the same entity responsible for operating the server. For example, the verifier may be part of an enhanced security method offered by a company offering Proof of Location services.

System 1300 includes a random seed generator 1310 configured to communicate a random seed to server 1306 and to third-party verifier 1308 (e.g., in response to user device 1304 communicating Verification-of-Location data to server 1306). The random seed is unique or practically unique to the verification request and/or to user device 1304 at the time of the verification request; for example, the seed may be based on a characteristic of the device, a timestamp, and/or any other suitable parameter(s). Server 1306 is configured to perform a test on the Verification-of-Location data communicated by user device 1304 to the server, the test being based at least in part on the random seed communicated by seed generator 1310. For example, the server may apply a software mask to the Verification-of-Location data communicated by user device 1304 to the server, with one or more aspects of the mask being based on the seed. In another example, the random seed may be (or may be based on) a previously generated point cloud of the trackable feature that user device 1304 scans to generate the Verification-of-Location data. The server compares the previously generated point cloud from the random seed to the Verification-of-Location data to determine whether user device 1304 is in view of the trackable feature at the location. Based on determining that the point cloud associated with the random seed is consistent with the Verification-of-Location data provided by the user device, server 1306 generates Proof of Location for user device 1304.

However, if a “Man-in-the-middle” (MITM) attacker 1302 is present, the MITM intercepts the random seed and the Verification-of-Location data prior to the seed and data reaching server 1306. MITM 1302 re-transmits the Verification-of-Location data to server 1306, but instead of re-transmitting the seed to the server, transmits to the server their own personal seed associated with their own personal device. Accordingly, server 1306 receives the MITM's substitute seed rather than the user's seed, along with the Verification-of-Location data. Server 1306 is unaware of MITM 1302 and tests the Verification-of-Location data using a test based on the MITM's seed. The MITM's seed is configured to produce a test that yields a positive result (i.e., confirmation of Proof of Location) when performed on the Verification-of-Location data, and so the server generates Proof of Location based on the Verification-of-Location data and the MITM's seed. The MITM thus obtains Proof of Location from the server even though the MITM is not present at the location.

To avoid this outcome, system 1300 is able to determine whether a MITM attacker is present by having seed generator 1310 generate a false seed on occasion (e.g., to generate a false seed on random occasions at which a real seed would otherwise have been generated) and communicate the false seed to server 1306 and third-party verifier 1308. The false seed is configured to cause server 1306 to deny Proof of Location in response to testing the Verification-of-Location data using a test based on the false seed. For example, the false seed may include a point cloud of a different trackable feature than the trackable feature scanned by user device 1304 to generate the Verification-of-Location data. In such examples, server 1306 should deny Proof of Location for user device 1304, because the Verification-of-Location data generated by user device 1304 is inconsistent with the false seed. Accordingly, if no MITM is present, then server 1306 denies Proof of Location and communicates the denial of Proof of Location result to third-party verifier 1308. Third-party verifier 1308 tests the seed communicated by seed generator 1310, determines that it was fake and that the server was correct to deny Proof of Location, and thus determines that no “Man-in-the-middle” is present. In response to determining that no “Man-in-the-middle” is present, seed generator 1310 may resume normal operations, e.g., communicate a second seed that is a true seed to server 1306. Server 1306 can then test the Verification-of-Location data based on the true seed to generate Proof of Location for user device 1304.

However, if MITM 1302 is present, MITM 1302 intercepts the false seed and the Verification-of-Location data being transmitted to the server. As described above, MITM 1302 replaces the intercepted false seed with their own seed (which is configured to produce a correct result when the server tests the Verification-of-Location data using a test based on the MITM seed) and communicates the MITM seed along with the Verification-of-Location data to server 1306. Server 1306 tests the Verification-of-Location data using a test based on the MITM seed and establishes a positive Proof of Location result for MITM 1302. Server 1306 communicates the positive Proof of Location result to third-party verifier 1308. Third-party verifier 1308 tests the seed communicated to it by seed generator 1310 (or in some cases, has already tested that seed) and determines that the original seed was fake. Accordingly, based on the positive Proof of Location result communicated by server 1306, verifier 1308 determines that a “Man-in-the-middle” is present who replaced the false seed with their own seed (because the false seed should have produced a denial of Proof of Location). In response to detecting the MITM in this manner, verifier 1308 may take any suitable action, such as sending a security alert and/or notification of denial of Proof of Location to user device 1304 and/or any other suitable device(s). In this manner, a third-party verifier configured to test seeds and occasionally generate false seeds can be utilized to deny Proof of Location for “Man-in-the-middle” attackers that otherwise would trick server 1306 into generating Proof of Location.

Verifier 1308 may perform any test on the seed transmitted by seed generator 1310 suitable for determining that a transmitted seed is false (e.g., is configured to produce a negative Proof of Location result). In some examples, verifier 1308 does not receive the Verification-of-Location data produced by device 1304 and determines whether a seed is false or real without using or even having the Verification-of-Location data. In other examples, however, the verifier does receive the Verification-of-Location data and determine whether the seed is false or real based in part on the Verification-of-Location data.

### J. Illustrative Data Processing System

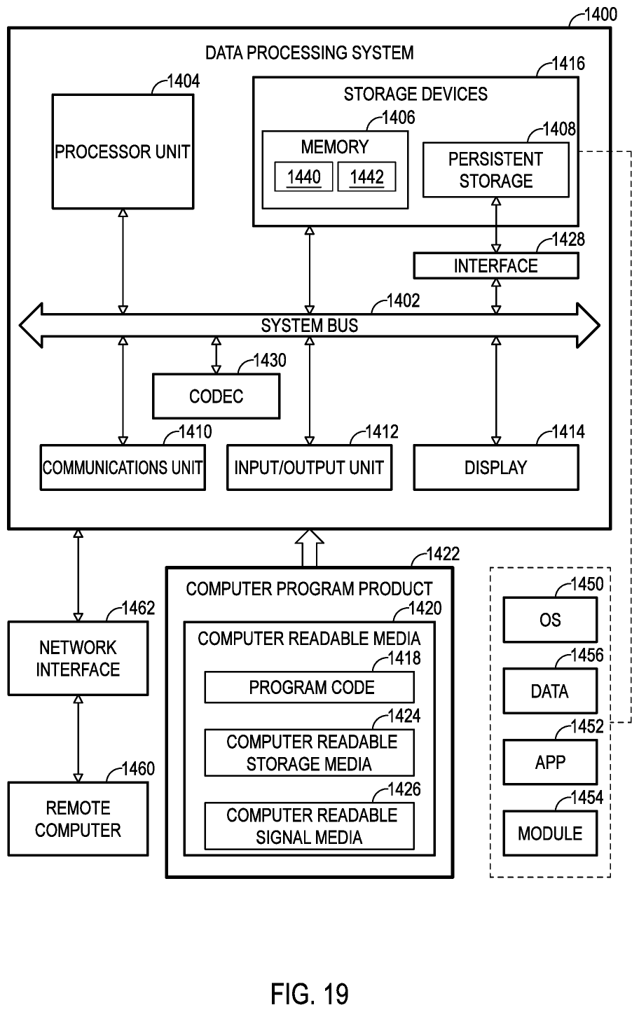

As shown in FIG. 19, this example describes a data processing system 1400 (also referred to as a computer, computing system, and/or computer system) in accordance with aspects of the present disclosure. In this example, data processing system 1400 is an illustrative data processing system suitable for implementing aspects of the Proof-of-Location system. More specifically, in some examples, devices that are embodiments of data processing systems (e.g., smartphones, tablets, personal computers) may image a location and generate Proof-of-Location data and/or Verification-of-Location data to be utilized by the data processing system or a remote verifier to verify proof of location for a user. In some examples, examples of data processing system 1400 are servers configured to implement aspects of Proof-of-Location systems in accordance with aspects of the present teachings. For example, a data processing system may act as a remote verifier of Verification-of-Location data.

In this illustrative example, data processing system 1400 includes a system bus 1402 (also referred to as communications framework). System bus 1402 may provide communications between a processor unit 1404 (also referred to as a processor or processors), a memory 1406, a persistent storage 1408, a communications unit 1410, an input/output (1/O) unit 1412, a codec 1430, and/or a display 1414. Memory 1406, persistent storage 1408, communications unit 1410, input/output (1/O) unit 1412, display 1414, and codec 1430 are examples of resources that may be accessible by processor unit 1404 via system bus 1402.

Processor unit 1404 serves to run instructions that may be loaded into memory 1406. Processor unit 1404 may comprise a number of processors, a multi-processor core, and/or a particular type of processor or processors (e.g., a central processing unit (CPU), graphics processing unit (GPU), etc.), depending on the particular implementation. Further, processor unit 1404 may be implemented using a number of heterogeneous processor systems in which a main processor is present with secondary processors on a single chip. As another illustrative example, processor unit 1404 may be a symmetric multi-processor system containing multiple processors of the same type.

Memory 1406 and persistent storage 1408 are examples of storage devices 1416. A storage device may include any suitable hardware capable of storing information (e.g., digital information), such as data, program code in functional form, and/or other suitable information, either on a temporary basis or a permanent basis.

Storage devices 1416 also may be referred to as computer-readable storage devices or computer-readable media. Memory 1406 may include a volatile storage memory 1440 and a non-volatile memory 1442. In some examples, a basic input/output system (BIOS), containing the basic routines to transfer information between elements within the data processing system 1400, such as during start-up, may be stored in non-volatile memory 1442. Persistent storage 1408 may take various forms, depending on the particular implementation.

Persistent storage 1408 may contain one or more components or devices. For example, persistent storage 1408 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 1408 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 1408 to system bus 1402, a removable or non-removable interface is typically used, such as interface 1428.

Input/output (I/O) unit 1412 allows for input and output of data with other devices that may be connected to data processing system 1400 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 1404 through system bus 1402 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 1400 and to output information from data processing system 1400 to an output device. One or more output adapters may be provided for certain output devices (e.g., monitors, speakers, and printers, among others) which require special adapters. Suitable output adapters may include, e.g. video and sound cards that provide a means of connection between the output device and system bus 1402. Other devices and/or systems of devices may provide both input and output capabilities, such as remote computer(s) 1460. Display 1414 may include any suitable human-machine interface or other mechanism configured to display information to a user, e.g., a CRT, LED, or LCD monitor or screen, etc.

Communications unit 1410 refers to any suitable hardware and/or software employed to provide for communications with other data processing systems or devices. While communication unit 1410 is shown inside data processing system 1400, it may in some examples be at least partially external to data processing system 1400. Communications unit 1410 may include internal and external technologies, e.g., modems (including regular telephone grade modems, cable modems, and DSL modems), ISDN adapters, and/or wired and wireless Ethernet cards, hubs, routers, etc. Data processing system 1400 may operate in a networked environment, using logical connections to one or more remote computers 1460. A remote computer(s) 1460 may include a personal computer (PC), a server, a router, a network PC, a workstation, a microprocessor-based appliance, a peer device, a smart phone, a tablet, another network note, and/or the like. Remote computer(s) 1460 typically include many of the elements described relative to data processing system 1400. Remote computer(s) 1460 may be logically connected to data processing system 1400 through a network interface 1462 which is connected to data processing system 1400 via communications unit 1410. Network interface 1462 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 1430 may include an encoder, a decoder, or both, comprising hardware, software, or a combination of hardware and software. Codec 1430 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 1430 is depicted as a separate component, codec 1430 may be contained or implemented in memory, e.g., non-volatile memory 1442.

Non-volatile memory 1442 may include read only memory (ROM), programmable ROM (PROM), electrically programmable ROM (EPROM), electrically erasable programmable ROM (EEPROM), flash memory, and/or the like, or any combination of these. Volatile memory 1440 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 1416, which are in communication with processor unit 1404 through system bus 1402. In these illustrative examples, the instructions are in a functional form in persistent storage 1408. These instructions may be loaded into memory 1406 for execution by processor unit 1404. Processes of one or more embodiments of the present disclosure may be performed by processor unit 1404 using computer-implemented instructions, which may be located in a memory, such as memory 1406.

These instructions are referred to as program instructions, program code, computer usable program code, or computer-readable program code executed by a processor in processor unit 1404. The program code in the different embodiments may be embodied on different physical or computer-readable storage media, such as memory 1406 or persistent storage 1408. Program code 1418 may be located in a functional form on computer-readable media 1420 that is selectively removable and may be loaded onto or transferred to data processing system 1400 for execution by processor unit 1404. Program code 1418 and computer-readable media 1420 form computer program product 1422 in these examples. In one example, computer-readable media 1420 may comprise computer-readable storage media 1424 or computer-readable signal media 1426.

Computer-readable storage media 1424 may include, for example, an optical or magnetic disk that is inserted or placed into a drive or other device that is part of persistent storage 1408 for transfer onto a storage device, such as a hard drive, that is part of persistent storage 1408. Computer-readable storage media 1424 also may take the form of a persistent storage, such as a hard drive, a thumb drive, or a flash memory, that is connected to data processing system 1400. In some instances, computer-readable storage media 1424 may not be removable from data processing system 1400.

In these examples, computer-readable storage media 1424 is a non-transitory, physical or tangible storage device used to store program code 1418 rather than a medium that propagates or transmits program code 1418. Computer-readable storage media 1424 is also referred to as a computer-readable tangible storage device or a computer-readable physical storage device. In other words, computer-readable storage media 1424 is media that can be touched by a person.

Alternatively, program code 1418 may be transferred to data processing system 1400, e.g., remotely over a network, using computer-readable signal media 1426. Computer-readable signal media 1426 may be, for example, a propagated data signal containing program code 1418. For example, computer-readable signal media 1426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1418 may be downloaded over a network to persistent storage 1408 from another device or data processing system through computer-readable signal media 1426 for use within data processing system 1400. For instance, program code stored in a computer-readable storage medium in a server data processing system may be downloaded over a network from the server to data processing system 1400. The computer providing program code 1418 may be a server computer, a client computer, or some other device capable of storing and transmitting program code 1418.

In some examples, program code 1418 may comprise an operating system (OS) 1450. Operating system 1450, which may be stored on persistent storage 1408, controls and allocates resources of data processing system 1400. One or more applications 1452 take advantage of the operating system's management of resources via program modules 1454, and program data 1456 stored on storage devices 1416. OS 1450 may include any suitable software system configured to manage and expose hardware resources of computer 1400 for sharing and use by applications 1452. In some examples, OS 1450 provides application programming interfaces (APIs) that facilitate connection of different type of hardware and/or provide applications 1452 access to hardware and OS services. In some examples, certain applications 1452 may provide further services for use by other applications 1452, e.g., as is the case with so-called “middleware.” Aspects of present disclosure may be implemented with respect to various operating systems or combinations of operating systems.

The different components illustrated for data processing system 1400 are not meant to provide architectural limitations to the manner in which different embodiments may be implemented. One or more embodiments of the present disclosure may be implemented in a data processing system that includes fewer components or includes components in addition to and/or in place of those illustrated for computer 1400. Other components shown in FIG. 19 can be varied from the examples depicted. Different embodiments may be implemented using any hardware device or system capable of running program code. As one example, data processing system 1400 may include organic components integrated with inorganic components and/or may be comprised entirely of organic components (excluding a human being). For example, a storage device may be comprised of an organic semiconductor.

In some examples, processor unit 1404 may take the form of a hardware unit having hardware circuits that are specifically manufactured or configured for a particular use, or to produce a particular outcome or progress. This type of hardware may perform operations without needing program code 1418 to be loaded into a memory from a storage device to be configured to perform the operations. For example, processor unit 1404 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 1418) may be implemented as hardware, e.g., by specifying an FPGA configuration using a hardware description language (HDL) and then using a resulting binary file to (re)configure the FPGA.

In another example, data processing system 1400 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 1404 may be implemented using a combination of processors found in computers and hardware units. Processor unit 1404 may have a number of hardware units and a number of processors that are configured to run program code 1418. With this depicted example, some of the processes may be implemented in the number of hardware units, while other processes may be implemented in the number of processors.

In another example, system bus 1402 may comprise one or more buses, such as a system bus or an input/output bus. Of course, the bus system may be implemented using any suitable type of architecture that provides for a transfer of data between different components or devices attached to the bus system. System bus 1402 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 1410 may include a number of devices that transmit data, receive data, or both transmit and receive data. Communications unit 1410 may be, for example, a modem or a network adapter, two network adapters, or some combination thereof. Further, a memory may be, for example, memory 1406, or a cache, such as that found in an interface and memory controller hub that may be present in system bus 1402.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### K. Illustrative Distributed Data Processing System

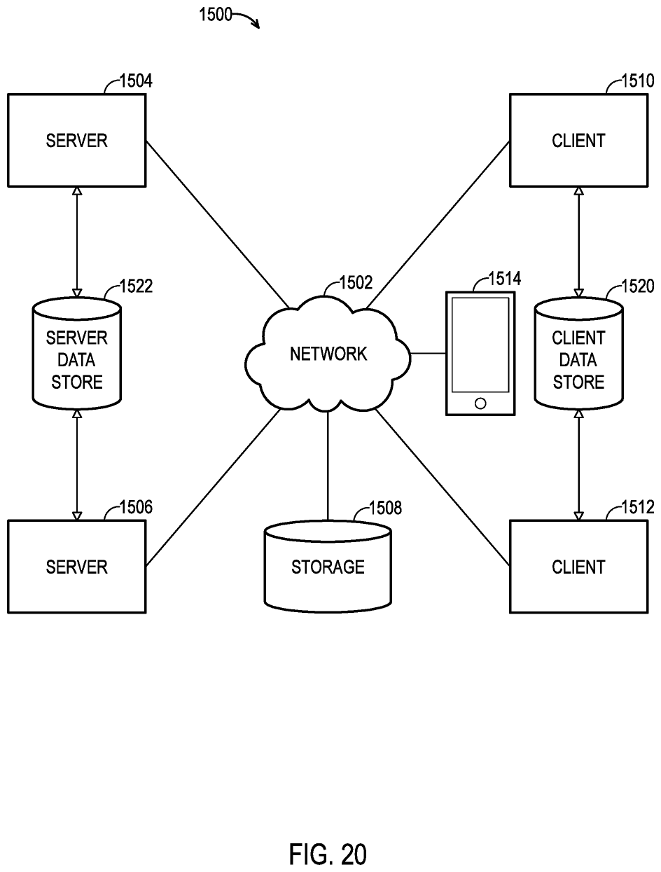

As shown in FIG. 20, this example describes a general network data processing system 1500, interchangeably termed a computer network, a network system, a distributed data processing system, or a distributed network, aspects of which may be included in one or more illustrative embodiments of the Proof-of-Location systems. For example, the user devices may be in network communication with other user devices, a server, a blockchain, and/or a third party. Proof-of-Location data and/or Verification-of-Location data may be transmitted between devices using a network.

It should be appreciated that FIG. 20 is provided as an illustration of one implementation and is not intended to imply any limitation with regard to environments in which different embodiments may be implemented. Many modifications to the depicted environment may be made.

Network system 1500 is a network of devices (e.g., computers), each of which may be an example of data processing system 1400, and other components. Network data processing system 1500 may include network 1502, which is a medium configured to provide communications links between various devices and computers connected within network data processing system 1500. Network 1502 may include connections such as wired or wireless communication links, fiber optic cables, and/or any other suitable medium for transmitting and/or communicating data between network devices, or any combination thereof.

In the depicted example, a first network device 1504 and a second network device 1506 connect to network 1502, as do one or more computer-readable memories or storage devices 1508. Network devices 1504 and 1506 are each examples of data processing system 1400, described above. In the depicted example, devices 1504 and 1506 are shown as server computers, which are in communication with one or more server data store(s) 1522 that may be employed to store information local to server computers 1504 and 1506, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 1510 and 1512 and/or a client smart device 1514, may connect to network 1502. Each of these devices is an example of data processing system 1400, described above regarding FIG. 19. Client electronic devices 1510, 1512, and 1514 may include, for example, one or more personal computers, network computers, and/or mobile computing devices such as personal digital assistants (PDAs), smart phones, handheld gaming devices, wearable devices, and/or tablet computers, and the like. In the depicted example, server 1504 provides information, such as boot files, operating system images, and applications to one or more of client electronic devices 1510, 1512, and 1514. Client electronic devices 1510, 1512, and 1514 may be referred to as “clients” in the context of their relationship to a server such as server computer 1504. Client devices may be in communication with one or more client data store(s) 1520, which may be employed to store information local to the clients (e.g., cookie(s) and/or associated contextual information). Network data processing system 1500 may include more or fewer servers and/or clients (or no servers or clients), as well as other devices not shown.

In some examples, first client electric device 1510 may transfer an encoded file to server 1504. Server 1504 can store the file, decode the file, and/or transmit the file to second client electric device 1512. In some examples, first client electric device 1510 may transfer an uncompressed file to server 1504 and server 1504 may compress the file. In some examples, server 1504 may encode text, audio, and/or video information, and transmit the information via network 1502 to one or more clients.

Client smart device 1514 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 1500 may be stored in or on a computer-readable storage medium, such as network-connected storage device 1508 and/or a persistent storage 1408 of one of the network computers, as described above, and may be downloaded to a data processing system or other device for use. For example, program code may be stored on a computer-readable storage medium on server computer 1504 and downloaded to client 1510 over network 1502, for use on client 1510. In some examples, client data store 1520 and server data store 1522 reside on one or more storage devices 1508 and/or 1408.

Network data processing system 1500 may be implemented as one or more of different types of networks. For example, system 1500 may include an intranet, a local area network (LAN), a wide area network (WAN), or a personal area network (PAN). In some examples, network data processing system 1500 includes the Internet, with network 1502 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 1502 may be referred to as a “cloud.” In those examples, each server 1504 may be referred to as a cloud computing node, and client electronic devices may be referred to as cloud consumers, or the like. FIG. 20 is intended as an example, and not as an architectural limitation for any illustrative embodiments.

### L. Illustrative Combinations and Additional Examples

A0. A method of obtaining proof of location of a user, the method comprising:

requesting, by a user device, proof-of-location data associated with a first location;

receiving, at the user device, the proof-of-location data associated with the first location;

capturing, by the user device, one or more images of an environment of the user device; and

based on the captured one or more images and the proof-of-location data, determining whether the user device is disposed at the first location.

A0.1 The method of paragraph A0, wherein determining whether the user device is disposed at the first location includes comparing the captured one or more images to the received proof-of-location data using processing logic of the user device.

A0.2 The method of any one of paragraphs A0-A0.1, wherein requesting proof-of-location data is performed by an app of the user device and capturing the one or more images is performed by an image sensor of the device.

A1. The method of any one of paragraphs A0-A0.2, wherein the proof-of-location data comprises data relating to a trackable feature disposed at the first location, and wherein determining whether the user device is located at the first location includes executing a computer vision algorithm configured to track to the trackable feature.

A2. The method of any one of paragraphs A0-A0.2, wherein determining whether the user device is disposed at the first location comprises:

generating verification-of-location data based on the one or more images and the proof-of-location data;

communicating, by the user device, the generated verification-of-location data to a remote verifier; and

receiving, from the remote verifier, a verification indicating the user device is disposed at the first location.

A3. The method of any one of paragraphs A0-A2, wherein determining whether the user is disposed at the first location comprises:

generating, by processing logic of the user device, a point cloud of a trackable feature in the one or more of the images captured by the user device, and

utilizing, by processing logic of the user device, the proof-of-location data to determine whether the point cloud was generated at the correct location.

A4. The method of paragraph A3, wherein a portion of the one or more images is masked when the point cloud is generated of the trackable feature.

A5. The method of any one of paragraphs A0-A4, wherein the proof-of-location data is received from a blockchain.

A6. The method of paragraph A2, further comprising communicating, by the user device, the verification of the location of the user device to a blockchain.

A7. The method of paragraph A3, wherein the proof-of-location data includes a numeric value, and wherein at least one aspect of the point cloud generated of the trackable feature is dependent on the numeric value.

A8. The method of paragraph A2, wherein the user device requests the proof-of-location data from a server, wherein the proof-of-location data is encrypted by the server, and wherein the method further comprises:

decrypting, by the user device, the proof-of-location data received from the server;

encrypting, by the user device, the verification-of-location data generated by the user device; and

communicating the encrypted verification-of-location data to the server.

A9. The method of paragraph A1, wherein the received proof-of-location data is partially encrypted such that the user device is able to track to the trackable feature without fully decrypting the proof-of-location data.

A10. The method of paragraph A1, wherein the proof-of-location data relating to the trackable feature at the first location comprises a point cloud of the trackable feature, and wherein tracking to the trackable feature comprises relocalizing the user device to the point cloud of the trackable feature.

A11. The method of paragraph A10, wherein the received point cloud of the trackable feature comprises a subset of a point cloud of the trackable feature stored at a server, wherein the subset of the point cloud is communicated to the user device by the server, and wherein the method further comprises:
generating, by the user device, the points of the point cloud not included in the received subset; and
communicating the generated points of the point cloud to the server.

A12. The method of any one of paragraphs A0-A12, wherein the proof-of-location data includes instructions directing a user of the user device to perform one or more actions while capturing the one or more images of the surrounding environment.

A13. The method of paragraph A9, wherein encrypting the proof-of-location data includes adding faulty data about the trackable feature.

A14. The method of paragraph A1, wherein the proof-of-location data is associated with the first location and with a first time of day corresponding to the current time of day when the proof-of-location data is requested by the user device.

A15. The method of paragraph A1, wherein the proof-of-location data includes data relating to multiple trackable features at the first location.

B0. A method of establishing proof of location, the method comprising:

receiving from a remote data store, at a mobile digital device, confirmation data associated with an expected signal expected to be receivable by the mobile digital device when the mobile digital device is within range of a first beacon disposed at a first fixed location;

receiving a signal at the mobile digital device at a first time; and

determining, based on the received signal and the confirmation data associated with the expected signal, whether the received signal was transmitted by the first beacon.

B1. The method of paragraph B0, wherein determining whether the received signal was transmitted by the first beacon is performed by the mobile digital device.

B2. The method of any one of paragraphs B0-B1, further comprising transmitting data associated with the received signal to a second device, wherein determining whether the received signal was transmitted by the first beacon is performed by the second device.

B3. The method of any one of paragraphs B0-B1, further comprising transmitting, from the mobile digital device to a second device, verification data indicating that the mobile digital device was within range of the first beacon at the first time.

B4. The method of any one of paragraphs B0-B3, wherein the first beacon comprises a laser.

B5. The method of any one of paragraphs B0-B4, wherein the expected signal is time-dependent such that information relating to a time of day at which the expected signal was transmitted is determinable based on the expected signal.

B6. The method of paragraph B5, wherein the expected signal includes a timestamp.

C0. A software app for a mobile digital device configured to generate verification-of-location data in accordance with any one or more aspects of the present teachings.

C1. A mobile digital device configured to generate verification-of-location data in accordance with any one or more aspects of the present teachings.

C2. A computing system configured to receive verification-of-location data and to determine, based on the received verification-of-location data, whether the verification-of-location data corresponds to a device disposed at a particular location.

C2.1 The computing system of paragraph C2, wherein the computing system comprises a server.

D0. A method for establishing proof of location of a computing system, the method comprising:

receiving first data at a first computing system;

generating second data at the first computing system based on the first data and on image data of an environment of the first computing system captured by an image sensor of the first computing system, wherein the image data includes image data of a trackable feature of the environment; and

communicating the second data to a second computing system.

D1. The method of paragraph D0, further comprising comparing the second data to reference data corresponding to an expected location of the first computing device and determining, based on the comparison, whether the environment of the first computing device corresponds to the expected location.

D2. The method of paragraph D0, wherein generating the second data at the first computing system comprises localizing the first computing system to the trackable feature of the environment based on the received first data.

D2.2 The method of paragraph D2, further comprising comparing the second data to reference data corresponding to data expected to be generated by a computing system localizing to the trackable feature of the environment.

D2.2.1 The method of paragraph D2.2, wherein the first data comprises an incomplete point cloud of the trackable feature, localizing to the trackable feature includes generating a more complete point cloud of the trackable feature, and comparing the second data to the reference data comprises comparing the generated more complete point cloud to an expected point cloud of the trackable feature of the environment.

D3. The method of any one of paragraphs D0-D1, wherein generating the second data at the first computing system comprises generating a point cloud of the trackable feature of the environment based on the received first data.

D3.1 The method of paragraph D3, further comprising comparing the generated point cloud to a reference point cloud of the trackable feature generated by another device at an earlier time.

D4. The method of any one of paragraphs D0-D3.1, wherein the first data includes an instruction to a user of the first computing system to move the image sensor of the first computing system in a particular pattern while capturing the image data, and the second data includes motion data sensed by a motion sensor of the first computing system based on the image sensor being moved in the particular pattern.

D4.1 The method of paragraph D4, wherein the motion sensor comprises an inertial measurement unit.

### Advantages, Features, and Benefits

Embodiments and examples of Proof-of-Location systems described herein provide several advantages over known solutions for verifying a location of an individual and/or of a device. For example, illustrative embodiments and examples described herein allow for the generation of Proof of Location for a user utilizing trackable physical feature(s) at a location.

Additionally, and among other benefits, illustrative embodiments and examples described herein allow a user to prove their location to a third party or other interested individual, entity, or system, utilizing only the user's mobile device (e.g., with no need for more specialized equipment).

Additionally, and among other benefits, illustrative embodiments and examples described herein allow for the use of anti-spoofing methods, such as masking, point cloud parametrization, salting, encryption, and/or any other suitable method. Utilizing anti-spoofing methods facilitates providing accurate Proof of Location and reduces the risk that Proof of Location will be falsely established by a malicious actor and/or erroneous data.

Additionally, and among other benefits, illustrative embodiments and examples described herein allow Proof of Location to be utilized for a variety of different purposes including, but not limited to, multi-factor authentication protocols, verification of fraudulent credit card activity, verification of a package delivery, and/or any other suitable purpose.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for generating proof of location, the method comprising:
receiving, at a mobile digital device, proof-of-location data associated with a real-world location;
capturing, using an image sensor of the mobile digital device, image data of an environment of the mobile digital device; and
determining, based on the proof-of-location data and the image data, whether the mobile digital device is disposed at the real-world location.

2. The method of claim 1, wherein the proof-of-location data includes first data configured to facilitate tracking to a trackable feature of the real-world location, and wherein determining whether the mobile digital device is disposed at the real-world location includes tracking to the trackable feature based on the captured image data.

3. The method of claim 2, wherein the first data includes a point cloud of the trackable feature and tracking to the trackable feature includes relocalizing the mobile digital device to the point cloud.

4. The method of claim 1, wherein the proof-of-location data includes an instruction to generate a point cloud corresponding to a trackable feature of the real-world location, and wherein determining whether the mobile digital device is disposed at the real-world location includes:
generating the point cloud of the trackable feature using the image data; and
comparing the generated point cloud to a reference point cloud.

5. The method of claim 4, wherein the proof-of-location data includes the reference point cloud.

6. The method of claim 5, wherein comparing the generated point cloud to the reference point cloud is performed at the mobile digital device.

7. The method of claim 4, further comprising communicating the generated point cloud to a remote server, wherein comparing the generated point cloud to the reference point cloud is performed at the remote server.

8. The method of claim 4, wherein generating the point cloud includes generating the point cloud based on a numeric parameter, and wherein determining whether the mobile digital device is disposed at the real-world location includes determining whether the generated point cloud is consistent with the numeric parameter.

9. The method of claim 8, wherein the received proof-of-location data includes the numeric parameter.

10. The method of claim 1, further comprising sending, from the mobile digital device to a remote device, a request to establish proof that the mobile digital device is at the real-world location, wherein the proof-of-location data received at the mobile digital device is sent by the remote device in response to the request.

11. The method of claim 1, further comprising masking the image data captured by the image sensor of the mobile digital device.

12. The method of claim 11, wherein masking the image data includes partially obscuring, by a physical object, a trackable feature in a field of view of the image sensor while the image sensor captures the image data.

13. The method of claim 11, wherein the proof-of-location data includes an instruction to generate a point cloud of a trackable feature of the real-world location, and wherein determining whether the mobile digital device is disposed at the real-world location includes:
generating a point cloud of the trackable feature using the masked image data; and
comparing the generated point cloud to a reference point cloud, the reference point cloud corresponding to a predicted point cloud of the trackable feature incorporating the mask.

14. The method of claim 13, wherein comparing the generated point cloud to the reference point cloud incorporating the mask is performed at a remote server.

15. The method of claim 1, wherein the proof-of-location data comprises faulty tracking data configured to inhibit a mobile digital device from tracking to a trackable feature of the real-world location, and wherein determining whether the mobile digital device is disposed at the real-world location includes:
attempting, using the mobile digital device, to track to the trackable feature using the faulty tracking data; and
in response to a successful attempt to track to the trackable feature using the faulty tracking data, determining that the mobile digital device is not disposed at the real-world location.

16. The method of claim 1, wherein the proof-of-location data further comprises an instruction to a user of the mobile digital device to move the mobile digital device in a specified motion while the image sensor captures the image data.

17. The method of claim 1, wherein the proof-of-location data includes only a first subset of points of a reference point cloud of a trackable feature disposed at the real-world location, and wherein determining whether the mobile digital device is disposed at the real-world location includes:
based on the first subset of points, localizing the mobile digital device to the trackable feature, wherein localizing the mobile digital device to the trackable features includes generating a complete point cloud of the trackable feature including the first subset of points and a second subset of points including at least one point absent from the first subset; and
transmitting the second subset of points to a remote device for comparison to the reference point cloud.

18. The method of claim 1, wherein receiving the proof-of-location data comprises obtaining the proof-of-location data from a blockchain.

19. The method of claim 1, wherein the received proof-of-location data includes data configured to facilitate tracking to a plurality of trackable features of the real-world location, and wherein determining whether the mobile digital device is disposed at the real-world location includes tracking to only a subset of the trackable features.

20. The method of claim 1, wherein the mobile digital device is a smart phone.
